(19) United States
(12) Patent Application Publication
(10) Pub. No.: US 2019/0141412 A1
(43) Pub. Date: May 9, 2019

(54) DISPLAY APPARATUS, CONTROL SYSTEM FOR THE SAME, AND METHOD FOR CONTROLLING THE SAME

(71) Applicant: SAMSUNG ELECTRONICS CO., LTD., Suwon-si (KR)

(72) Inventors: Sang Young LEE, Suwon-si (KR); Hee Seok JEONG, Suwon-si (KR); Ho Yeon KIM, Suwon-si (KR); Kyu Hyun CHO, Suwon-si (KR); Young Tae KIM, Suwon-si (KR)

(73) Assignee: SAMSUNG ELECTRONICS CO., LTD., Suwon-si (KR)

(21) Appl. No.: 16/183,043

(22) Filed: Nov. 7, 2018

(30) Foreign Application Priority Data
Nov. 7, 2017 (KR) 10-2017-0147077

(51) Int. Cl. H04N 21/81; H04N 21/41; H04N 21/437; H04N 21/2668; H04N 21/431; H04N 21/436

(52) U.S. Cl. CPC H04N 21/8133; H04N 21/4126; H04N 21/436; H04N 21/2668; H04N 21/4316; H04N 21/437

(57) ABSTRACT

Disclosed herein are a display apparatus, control system for the display apparatus, and a method for controlling the display apparatus. The display apparatus includes a receiver configured to receive content, a display configured to display the received content, a communicator configured to communicate with a user device and an external server. The display apparatus includes a processor configured to acquire information from the user device through the communicator, to request the external server to send additional information related to the received content based on the received content and the information, and to display, when receiving the additional information related to the received content from the external server, the received additional information with the received content.

### CROSS-REFERENCE TO RELATED APPLICATION

This application is based on and claims priority under 35 U.S.C. § 119 to Korean Patent Application No. 10-2017-0147077, filed on Nov. 7, 2017 in the Korean Intellectual Property Office, the disclosure of which is incorporated by reference herein in its entirety.

### BACKGROUND

### 1. Field

The present disclosure relates to a display apparatus, a control system for the same, and a method for controlling the same.

### 2. Description of the Related Art

A display apparatus is a kind of apparatus that converts electrical signals into visual information to display the visual information for users. The display apparatus includes, for example, a digital television, a monitor apparatus, a laptop computer, a smart phone, a tablet PC, a Head-Mounted Display (HMD) apparatus, and a navigation system.

Recently, a display apparatus such as a digital television reproduces images transmitted from an external content provider (for example, a broadcasting station or a video streaming service provider), and also acquires information related to the images through the Internet, etc. to display the information visually. Also, the display apparatus executes a predetermined application (also referred to as a program or app) to perform a predetermined function.

Also, a plurality of display apparatuses are connected to each other through a wired communication network and/or a wireless communication network to communicate with each other. Accordingly, images reproduced on a display apparatus (for example, a digital television) or various information related to the image is reproduced or displayed on another apparatus (for example, a smart phone), etc.

### SUMMARY

Therefore, it is an aspect of the present disclosure to provide a display apparatus capable of intuitively and properly providing a viewer with information related to content being currently reproduced or the viewer's desired information, without interfering with the viewer's watching, control system of the display apparatus, and a method of controlling the display apparatus.

Additional aspects of the disclosure will be set forth in part in the description which follows and, in part, will be obvious from the description, or may be learned by practice of the disclosure.

In order to overcome problems in existing systems and apparatuses, a display apparatus, control system for the display apparatus, and a method of controlling the display apparatus are provided.

In accordance with an aspect of the present disclosure, there is provided a display apparatus including a receiver configured to receive content; a display configured to display the received content, a communicator configured to communicate with a user device and an external server, and a processor configured to acquire information from the user device through the communicator, to request the external server to send additional information related to the received content based on the received content and the information acquired from the user device, and to display, when receiving the additional information related to the received content from the external server, the received additional information with the received content.

The processor may arrange the received additional information around the received content in a shape of a plane, a sphere, a hemisphere, a cylinder, or a band to display the received additional information around the received content.

The processor may display the received additional information around the received content based on one or more of a degree of association between the received additional information and the received content, quality of the received additional information, a preference of the received additional information, a format of the received additional information, and a kind of the received additional information, and displays the received additional information adjacent to the received content according to the one or more of the degree of association between the received additional information and the received content, the quality of the received additional information, and the preference of the received additional information.

The communicator may receive a user command including at least one selection of a direction from the user device, and the processor may decide content disposed in a direction corresponding to the at least one selection of the direction from the content displayed on the display, as content that is to be provided by the display.

The processor may analyze the received content and the information, and conducts a search related to the received content based on a result of the analysis to acquire the additional information.

The processor may analyze the received content and the user information based on one or more of machine learning, a region of interest (ROI) selection algorithm, and an image segmentation algorithm.

The user information may include one or more of content, text, and a use history of the user device, stored in the user device.

The communicator may transmit an entire or a part of the received content, an entire or a part of the received additional information, and one or more of arrangements of the received additional information to the user device, and the user device may display at least one of the received content and the received additional information independently or dependently according to a pre-defined setting.

The communicator may transmit a text input request to the user device, and receive information about whether text is able to be input from the user device.

The processor may request the external server to send a search method of searching the additional information related to the received content according to information about the received content and the information through the communicator, and search the additional information related to the received content according to the search method received from the external server.

The display may further include a first display configured to display the received content, and one or more second display configured to display the received additional information.

In accordance with another aspect of the present disclosure, there is provided a method of controlling a display apparatus, including: receiving information from a user device; receiving content; requesting an external server to send additional information related to the received content based on the received content and the information received from the user device; and displaying, when the additional information related to the received content is received from the external server, the received additional information with the received content.

The received additional information may be arranged in a shape of a plane, a sphere, a hemisphere, a cylinder, or a band, and displayed around the received content.

The displaying of the received additional information around the received content may include displaying the received additional information around the received content based on one or more of a degree of association between the received additional information and the received content, quality of the received additional information, a preference of the received additional information, a format of the received additional information, and a kind of the received additional information, and displaying the received additional information adjacent to the received content according to the one or more of the degree of association between the received additional information and the received content, the quality of the received additional information, and the preference of the received additional information.

The method may further include: acquiring a user command including at least one selection of direction from the user device; and deciding content disposed in a direction corresponding to the at least one selection of the direction from the displayed content, as content that is to be displayed.

The method may further include acquiring the received content and the information to analyze the received content and the information, wherein the acquiring of the received content and the information and the analyzing of the received content and the information comprises analyzing the received content and the information based on one or more machine learning, a region of interest (ROI) selection algorithm, and an image segmentation algorithm.

The method may further include transmitting an entire or a part of the received content, an entire or a part of the received additional information, and one or more arrangements of the received additional information to the user device, so that the user device displays at least one of the received content and the received additional information independently or dependently according to a pre-defined setting.

The method may further include: transmitting a text input request to a user device; determining whether text is able to be input to the user device; receiving information about whether text is able to be input to the user device from the user device.

The method may further include: transmitting the received content and the information to the external server; analyzing the received content and the information by the external server to decide information about acquisition of additional information for the received content; and receiving the information about acquisition of additional information for the received content from the external server.

In accordance with another aspect of the present disclosure, there is provided control system of a display apparatus, including: an external server; and a display apparatus communicatively connected to the external server, wherein the display apparatus acquires content and information, and transmits the content and the information to the external server, the external server decides an additional information acquiring method based on the content and the information, and transmits the additional information acquiring method to the display apparatus; and the display apparatus acquires additional information related to the content based on the additional information acquiring method, and displays the additional information related to the content with the content.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 shows an embodiment of entire system;

FIG. 2 is a block diagram of an embodiment of a terminal;

FIG. 3 is a block diagram of an embodiment of a display apparatus;

FIG. 4 shows an example of content that is to be analyzed;

FIG. 5 shows an example of a virtual arrangement of content and additional information;

FIG. 6 shows an example of a screen on which a plurality of additional information is displayed;

FIG. 7 shows another example of a virtual arrangement of content and additional information;

FIG. 8 shows another example of a virtual arrangement of content and additional information;

FIG. 9 shows another example of a virtual arrangement of content and additional information;

FIG. 10 shows the outer appearance of an example of a remote controller;

FIG. 11 shows an example of additional information displayed according to an operation of a remote controller;

FIG. 12 shows another example of additional information displayed according to an operation of a remote controller;

FIG. 13 shows another example of additional information displayed according to an operation of a remote controller;

FIG. 14 shows an example in which a terminal displays content in correspondence to a display apparatus;

FIG. 15 shows another example in which a terminal displays content in correspondence to a display apparatus;

FIG. 16 shows another example in which a terminal displays content in correspondence to a display apparatus;

FIG. 17 is a first view showing an example of controlling a display apparatus through a terminal;

FIG. 18 is a second view showing an example of controlling a display apparatus through a terminal;

FIG. 19 shows an example of receiving a symbol through a terminal;

FIG. 20 shows another embodiment of entire system;

FIG. 21 shows another embodiment of a display apparatus;

FIG. 22 shows an example of another embodiment of a display apparatus; and

FIG. 23 is a flowchart showing an embodiment of a control method of a display apparatus.

### DETAILED DESCRIPTION

Hereinafter, like reference numerals will refer to like components throughout this specification under no special circumstances. As used herein, the terms “unit”, “device, “block”, “member”, “module”, “portion” or “part” may be implemented as software or hardware, and according to embodiments, the “unit”, “device, “block”, “member”, “module”, “portion” or “part” may be implemented as a single component or a plurality of components.

In this specification, it will be understood that the case in which a certain part is “connected” to another part includes the case in which the part is “electrically connected” to the other part, as well as the case in which the part is “physically connected” to the other part.

Also, it will be understood that when a certain part “includes” a certain component, the part does not exclude another component but can further include another component, unless the context clearly dictates otherwise.

In this specification, the terms “first” and “second”, etc., may be used in correspondence to components or operations regardless of importance or order and are used to distinguish a component or operation from another without limiting the components or operations.

Also, it is to be understood that the singular forms “a,” “an,” and “the” include plural referents unless the context clearly dictates otherwise.

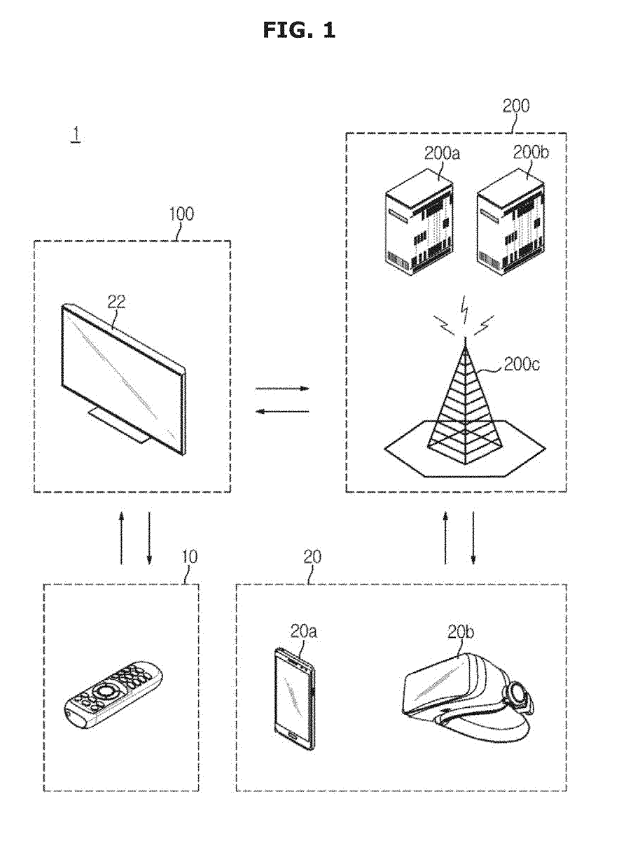

Hereinafter, a display apparatus and control system of the display apparatus will be described with reference to FIGS. 1 to 20.

FIG. 1 shows an embodiment of entire system.

As shown in FIG. 1, display apparatus control system 1 according to an embodiment may include a display apparatus 100, a remote controller 10 for controlling the display apparatus 100 remotely, at least one terminal 20 connected to the display apparatus 100 in such a way to be communicable with the display apparatus 100, and a content provider 200 connected to the display apparatus 100 and the terminal 20 in such a way to be communicable with the display apparatus 100 and the terminal 20. Some of the above-mentioned components may be omitted according to embodiments.

The remote controller 10 may transmit a signal corresponding to a user's operation to the display apparatus 100 using a pre-defined communication method. Herein, the pre-defined communication method may include, for example, an infrared communication method, an ultrasonic communication method, etc.

The at least one terminal 20 may communicate with the display apparatus 100 through a wired communication network, a wireless communication network, or a combination thereof. The wired communication network may be established by a cable, and the cable may be, for example, a pair cable, a coaxial cable, an optical fiber cable, an Ethernet cable, etc. The wireless communication network may be at least one of a short-range communication network and a long-distance communication network. Herein, the short-range communication network may be implemented with, for example, Wireless-Fidelity (Wi-Fi), zigbee, Bluetooth, Wi-Fi Direct, Bluetooth Low Energy, Controller Area Network (CAN) communication, Near Field Communication (NFC), etc. The long-distance communication network may be implemented based on a mobile communication standard of, for example, 3GPP, 3GPP2, or Worldwide Interoperability for Microwave Access (WiMAX) series. When the at least one terminal 20 communicates with the display apparatus 100 through a short-range communication network, the at least one terminal 20 may receive content, etc. from the display apparatus 100 or transmit user commands to the display apparatus 100 as long as the terminal 20 is located within a predetermined distance from the display apparatus 100. When the at least one terminal 20 communicates with the display apparatus 100 through a long-distance communication network, the at least one terminal 20 may receive content, etc. from the display apparatus 100 or transmit user commands to the display apparatus 100 although the terminal 20 is actually far away from the display apparatus 100. In other words, when a long-distance communication network is used, a user may view/listen to content of the display apparatus 100 or control the display apparatus 100 through the terminal 20 outside home, although the display apparatus 100 is installed inside the home.

According to an embodiment, the display apparatus control system 1 may include a single terminal 20 or two or more terminals 20a and 20b. The two or more terminals 20a and 20b may be the same kind of display apparatuses or different kinds of display apparatuses. For example, any one of the two terminals 20a and 20b may be a smart phone 20a, and the other one may be a Head Mounted Display (HMD) apparatus 20b.

The at least one terminal 20 may be an apparatus capable of communicating with the display apparatus 100 and outputting content received from the display apparatus 100 to the outside. For example, the at least one terminal 20 may be a smart phone, a tablet PC, a HMD apparatus, a smart watch, a digital television, a set-top box, a desktop computer, a laptop computer, navigation system, Personal Digital Assistant (PDA), a portable game, an electronic board, an electron signboard, or a sound reproducing apparatus capable of reproducing sound files produced based on the MP3 standard.

The display apparatus 100 may be an apparatus capable of outputting predetermined content visually and/or aurally. Herein, the content may be text, such as symbols or characters, a still image, a moving image, voice, sound and/or a combination of at least two of them. The content that is output from the display apparatus 100 may be content stored in the display apparatus 100, and/or content received in real time or in non-real time from the external content provider 200.

The display apparatus 100 may be, for example, a digital television, an electronic board, a desktop computer, a laptop computer, a monitor apparatus, a HMD apparatus, a smart watch, a smart phone, a tablet PC, a navigation system, a portable game, an electron signboard, or other various apparatuses capable of displaying images.

The display apparatus 100 may be connected to at least one of the terminal 20 and the content provider 200 through at least one of a wired communication network and a wireless communication network to transmit and/or receive various data. According to an embodiment, the display apparatus control system 1 may further include a set-top box (not shown) for connecting the display apparatus 100 to at least one of the terminal 20 and the content provider 200. The set-top box may be physically separated from the display apparatus 100 as necessary, or installed in the display apparatus 100.

According to an embodiment, the display apparatus 100 may analyze at least one content (hereinafter, simply referred to as content) of predetermined content, and acquire at least another content (hereinafter, referred to as additional information) corresponding to the at least one content based on the result of the analysis by receiving the additional information from another external apparatus, for example, at least one of the content provider 200 and the terminal 20 or by creating the additional information by itself. In this case, the display apparatus 100 may further acquire user-related information transferred from the terminal 20, etc., and further analyze the user-related information to thereby acquire the additional information.

Also, the display apparatus 100 may virtually arrange content and at least one content in a predetermined form (hereinafter, referred to as a virtual arrangement) according to a predetermined definition. Also, the display apparatus 100 may decide content that is to be provided to a user, according to a command (hereinafter, referred to as a user command) input by the user or according to a pre-defined setting. In this case, the display apparatus 100 may decide content that is to be provided, using the virtual arrangement.

Operations of the display apparatus 100 will be described in detail, later.

The content provider 200 may be an apparatus capable of providing at least one content to the display apparatus 100 sequentially or in response to a request signal received from the display apparatus 100.

The content provider 200 may be, for example, a server 200a of a video provider, such as a Video On Demand (VOD) provider, an Audio On Demand (AOD) provider, or an Over The Top (OTT) provider, and/or a web server 200b configured to allow external devices to access stored or mirrored data, such as images, sound, or text. Also, the content provider 200 may be a broadcasting transmitter 200c of a terrestrial broadcast provider or a cable broadcast provider. Also, the content provider 200 may be a server that implements an electronic software distribution network for providing applications (also referred to as programs or apps). Also, the content provider 200 may include all various apparatuses that provide content to the display apparatus 100 through a predetermined communication network, in addition to the above-described examples.

The display apparatus 100 may be connected directly or indirectly to the content provider 200 according to a user command or a pre-defined setting to receive various data (for example, video) required for operations of the display apparatus 100 from the content provider 200.

Hereinafter, an embodiment of the terminal 20 will be described in more detail.

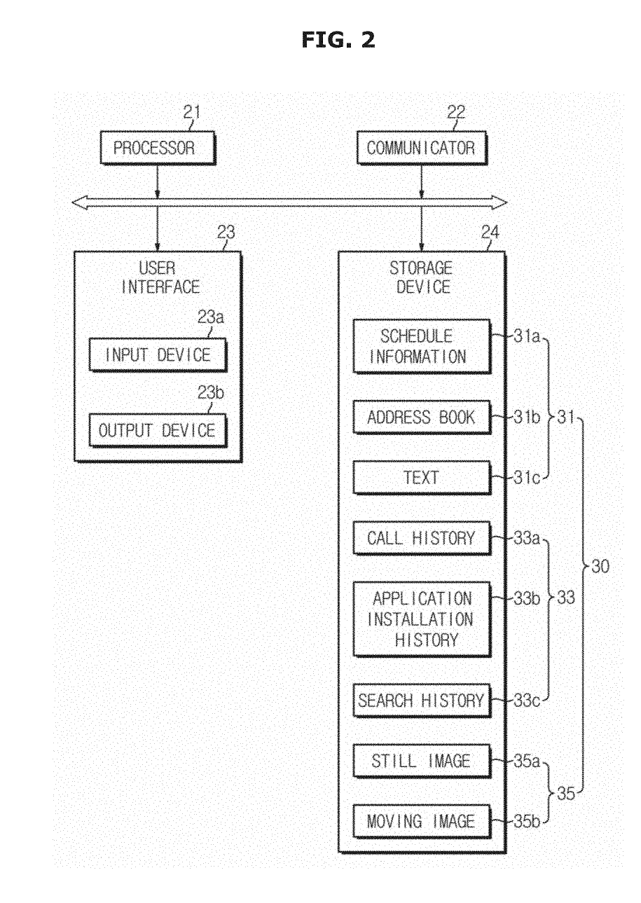

FIG. 2 is a block diagram of an embodiment of a terminal.

The terminal 20 may include, as shown in FIG. 2, a processor 21, a communicator 22, a user interface 23, and a storage device 24.

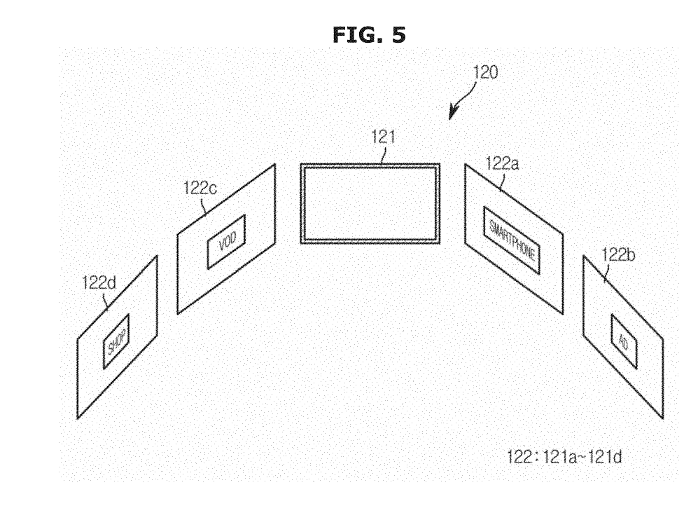

The processor 21 may control overall operations of the terminal 20. For example, the processor 21 may enable a display apparatus 100 to display content (121 of FIG. 5), additional information (122 of FIG. 5) and/or a virtual arrangement (120 of FIG. 5), received from the display apparatus 100, and/or transfer various information 20 stored in the storage device 24 to the display apparatus 100 according to a request from the display apparatus 100.

Also, the processor 21 may execute a predetermined application to control the individual components (not shown) of the terminal 20 so that the terminal 20 performs a predetermined function, for example, a call function, a function of photographing still images or moving images, and/or an Internet connecting function, etc.

The processor 21 may be implemented with, for example, a Central Processing Unit (CPU), a Micro Controller Unit (MCU), a Micro Processor (Micom), an Application Processor (AP), an Electronic Controlling Unit (ECU), and/or another electronic device capable of processing various operations and generating control signals.

The communicator 22 may communicate with an external device, for example, the display apparatus 100 or the content provider 200 to transmit/receive predetermined information to/from the display apparatus 100 or the content provider 200. The communicator 22 may be implemented with a communication chip, an antenna, and related components to connect to at least one of a wired communication network and a wireless communication network.

The user interface 23 may receive a user command from a user and/or provide the user with predetermined information (for example, at least one of content, additional information and a virtual arrangement) visually/aurally.

The user interface 23 may include an input device 23a for receiving commands from the user, and an output device (also, referred to as a display) 23b for providing predetermined information visually and/or aurally.

After the output device 23b displays the content 121, the additional information 122, or the virtual arrangement 120, the input device 23a may receive a command for changing the displayed image from the user. The output device 23b may display the content 121 or the additional information 122 according to an operation of the input device 23a. According to an embodiment, a user command received by the input device 23a may be transferred to the display apparatus 100 through the communicator 22, and the display apparatus 100 may decide an image to be displayed in response to the user command, and display the decided image instead of a currently displayed image.

The input device 23a may be implemented with a physical button, a trackball, a track pad, a keyboard, a mouse, and/or a touch sensor of a touch screen. The touch sensor may be disposed on one surface of a display panel which is the output device 23b or around the display panel to sense a touch operation made on the display panel. The touch sensor may sense a touch operation made on the display panel using any one method among a resistive method, a capacitive method, an infrared method, and a Surface Acoustic Wave (SAW) method.

When the terminal 20 is a HMD apparatus, the input device 23a may include a motion sensor for acquiring information about a direction which the HMD apparatus faces.

According to an embodiment, the output device 23b may include a display panel for displaying images. In this case, according to an embodiment, the output device 23b may display the content 121, the additional information 122 and/or the virtual arrangement 120 received from the display apparatus 100 in the same form as the display apparatus 100 or in a different form from the display apparatus 100. In this case, the output device 23b may display the content 121, the additional information 122, and/or the virtual arrangement 120 independently from the display apparatus 100 or depending on the display apparatus 100.

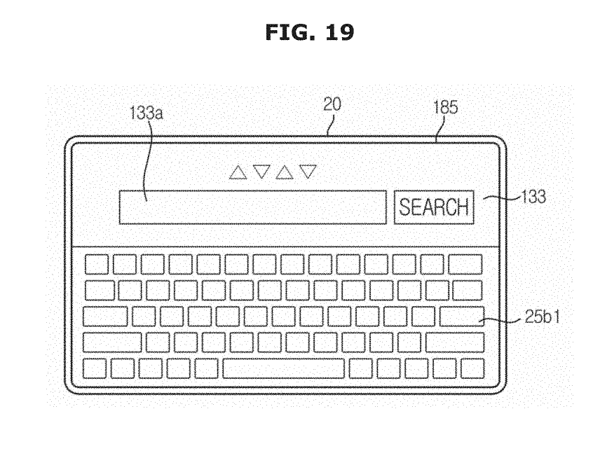

According to an embodiment, the output device 23b may further display a virtual keyboard (25b1 of FIG. 19) according to the control of the processor 21. In this case, the processor 21 may generate a control signal for displaying the virtual keyboard 25b1 based on a control command received from the display apparatus 100, and transfer the control signal to the output device 23b so that the output device 23b displays the virtual keyboard 25b1.

The display panel described above may display a predetermined screen according to the control of the processor 21 to provide the predetermined screen for a user. Herein, the display panel may be implemented with, for example, a Plasma Display Panel (PDP), a Light Emitting Diode (LED) display panel, and/or a Liquid Crystal Display (LCD). Herein, the LED display panel may be an Organic Light Emitting Diode (OLED) display panel, wherein the OLED may be Passive Matrix OLED (PMOLED) or Active Matrix OLED (AMOLED). According to an embodiment, the display 190 may be a Cathode Ray Tube (CRT). Also, the display 190 may be one of various apparatuses that can display a screen, other than the above-described examples.

Also, the output device 23b may be a speaker for outputting voice or sound, or a sound output apparatus such as earphones.

The storage device 24 may store various data required for operations of the terminal 20 temporarily or non-temporarily. The storage device 24 may be at least one of main memory and auxiliary memory. The main memory may be implemented with a semiconductor storage medium, such as Read Only Memory (ROM) and/or Random Access Memory (RAM). The ROM may be, for example, general ROM, Erasable Programming ROM (EPROM), Electrically Erasable and Programmable ROM (EEPROM) and/or Mask ROM (MROM). The RAM may be, for example, Dynamic RAM (DRAM) and/or Static RAM (SRAM).The auxiliary memory may be implemented with at least one storage medium that stores data permanently or semi-permanently, such as flash memory, a Secure Digital (SD) card, a Solid State Drive (SSD), a Hard Disc Drive (HDD), a magnetic drum, a Compact Disc (CD), optical media (for example, a DVD or a laser disc), a magnetic tape, a magneto-optical disc, and/or a floppy disc.

According to an embodiment, the storage device 24 may store various information 30 (hereinafter, also referred to as user-related information) related to a user of the terminal 20. The user-related information 30 may include at least one among various text information 31, a use history 33 of the terminal 20, and content 35 such as images. The various text information 31 may include, for example, schedule information 31a, address book database 31b and/or various text 31c such as document or messages (including short messages, multimedia messages and/or messages in messenger applications, and further including transmission and reception times of the messages and additional data such as a sender and/or a receiver, as necessary). In addition, the text information 31 may include various data that can be represented in the form of text. The use history 33 may include various data related to use of the terminal 20, such as, for example, a call history 33a, an application installation history 33b, and/or a search history 33c. The content 35 may include a still image 35a and/or a moving image 35b. The still image 35a and/or the moving image 35b may be an image photographed by the terminal 20 or produced based on an image producing application installed in the terminal 20. Alternatively, the still image 35a and/or the moving image 35b may be an image received by the terminal 20 from an external application server or a web server. The user-related information 30 may include other various information (for example, position information of the terminal 20) or content (for example, a sound source) that can be considered by a designer, in addition to the above-mentioned information.

Hereinafter, an example of the display apparatus 100 will be described in more detail.

Detailed descriptions about the substantially same components as those included in the terminal 20 among components that are to be described below will be omitted.

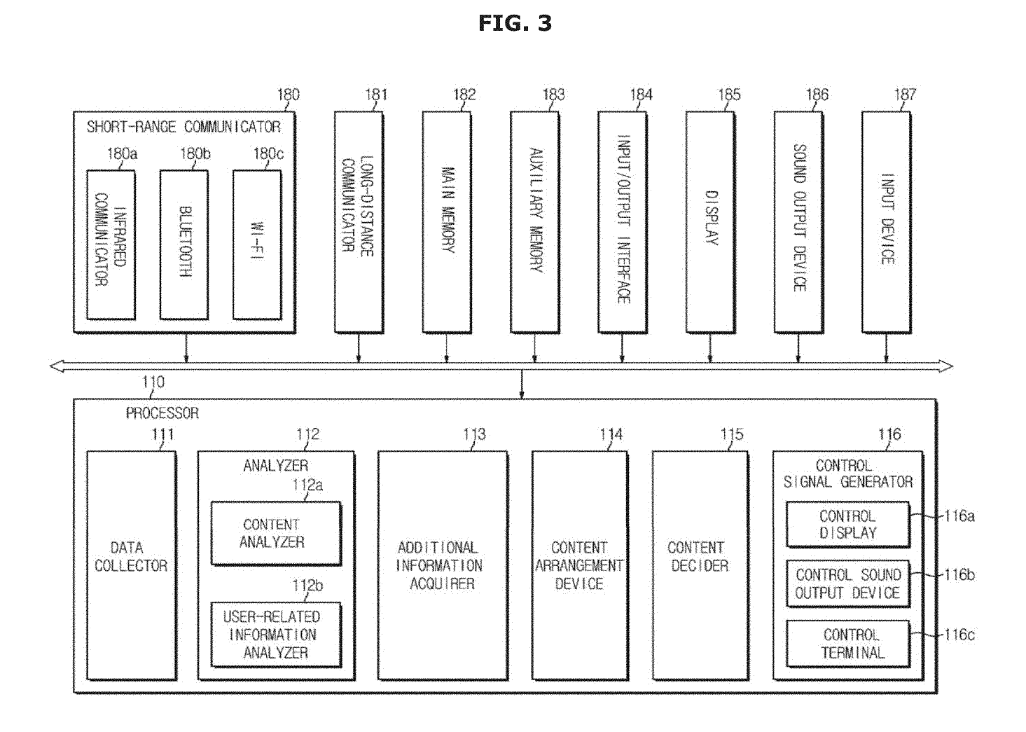

FIG. 3 is a block diagram of an embodiment of a display apparatus.

As shown in FIG. 3, the display apparatus 100 may include a short-range communicator 180, a long-distance communicator 181, main memory 182, auxiliary memory 183, an input/output interface 184, a display 185, a sound output device 186, an input device 187, and a processor 110. According to an embodiment, at least one of the above-mentioned components may be omitted.

The short-range communicator 180 may communicate with another apparatus (for example, the remote controller 10 or the terminal 20) located at a short distance from the display apparatus 100. The short-range communicator 180 may include, for example, an infrared communicator 180a for communicating with the remote controller 10, or Bluetooth 180b or Wi-Fi 180c for communicating with the terminal 20. Also, the short-range communicator 180 may include an apparatus (or apparatuses) based on another short-range communication technique, for example, Zigbee, Wi-Fi Direct, Bluetooth Low Energy (BLE), CAN, etc., in addition to or instead of the above-mentioned apparatuses.

The long-distance communicator 181 may communicate with another apparatus located at a short or long distance from the display apparatus 100. The long-distance communicator 181 may be connected to a wired communication network and/or a wireless communication network to enable data transmission/reception to/from the terminal 20 and/or the content provider 200 located at a short or long distance from the display apparatus 100.

The main memory 182 may temporarily store various information, such as data to be processed by the processor 110 or at least one frame of an image to be displayed by the display 185, in order to assist operations of the processor 110. For example, when the content 121 is analyzed, the main memory 182 may temporarily store the content 121 or information extracted from the content 121.

The auxiliary memory 183 may store various kinds of information required for operations of the display apparatus 100. For example, the auxiliary memory 183 may store a use history (for example, information about reproduced images, a history about channel selections, information about a driving time of the display apparatus 100, etc.) of the display apparatus 100, temporarily or non-temporarily store content received from the content provider 200, store content received through the input/output interface 184, store the additional information 122 decided according to processing of the processor 110, store the virtual arrangement 120 of the content 121 and the additional information 122, and/or store an application for enabling the processor 110 to perform a predetermined operation. Herein, the application stored in the auxiliary memory 183 may be an application programmed in advance by a designer and then directly transferred to and stored in the auxiliary memory 183, or an application acquired or updated through an external electronic software distribution network to which the display apparatus 100 can be connected through a wired or wireless communication network.

The display apparatus 100 may further include another memory such as buffer memory for temporarily storing image frames, as necessary.

The input/output interface 184 may connect the display apparatus 100 to another apparatus (for example, an external storage device or a set-top box) physically separated from the display apparatus 100. In this case, the other apparatus may be installed in the input/output interface 184 and connected to the display apparatus 100. The input/output interface 184 may receive content and/or user-related information 30 from the other apparatus, and transfer the received content and/or the user-related information 30 to the processor 110 and/or the memory 182 or 183. The input/output interface 184 may include at least one of various interface terminals, such as a Universal Serial Bus (USB) terminal, a High Definition Multimedia Interface (HDMI) terminal, or a thunderbolt terminal.

The display 185 may display images visually. According to an embodiment, the display 185 may visually display at least one of the content 121 and the additional information 122 under the control of the processor 110. In other words, the display 185 may output a moving image or a still image included in the content 121 and/or a moving image or a still image included in the additional information 122 to the outside to provide it to a user.

The display 185 may be implemented with a predetermined display panel, such as a LED display panel or a LCD panel, as described above, and may be implemented with a CRT as necessary. Also, the display 185 may include a projector that irradiates a laser beam on a flat surface to form images.

The display 185 may display predetermined content, for example, the content 121, and according to a user's operation, the display 185 may display the additional information 122.

The sound output device 186 may output voice and/or sound aurally. The sound output device 186 may aurally output at least one of the content 121 and the additional information 122 under the control of the processor 110. In other words, the sound output device 186 may output sound/voice included in the content 121 or sound/voice included in the additional information 122 to the outside to provide the sound/voice to a user.

The input device 187 may receive a user command related to operations of the display apparatus 100. The input device 187 may be installed directly on an external housing of the display apparatus 100, or implemented as another apparatus provided separately and connected to the input/output interface 184. More specifically, the input device 187 may include a physical button, a keyboard, a trackball, a track pad, a touch sensor of a touch screen or a touch pad, a mouse, and/or a tablet.

The input device 187 may receive a command for changing content to be displayed by the display 185 or to be output by the sound output device 186, in addition to or instead of the remote controller 10 or the terminal 20.

The processor 110 may perform various operations and control processing related to the display apparatus 100 to thereby control overall operations of the display apparatus 100. For example, the processor 110 may execute an application stored in the main memory 182 or the auxiliary memory 183 to perform a pre-defined operation, determination, processing, and/or control operation, thereby controlling the display apparatus 100.

As described above, the processor 110 may be implemented with, for example, a CPU, a MCU, a Micom, an AP, an ECU, and/or another electronic device capable of processing various operations and generating control signals.

According to an embodiment, the processor 110 may acquire and analyze content 121 and user-related information 30, and acquire at least one additional information 122 related to the content 121 and the user-related information 30. Also, the processor 110 may arrange the content 121 and the at least one additional information 122 depending on a pre-defined virtual arrangement 120. Also, the processor 110 may determine which one of the content 121 and the at least one additional information 122 is output through the output device (at least one of the display 185 and the sound output device 186) based on a user's command and the result of the arrangement, and control the display apparatus 100 based on the determination. In this case, the processor 110 may further generate a control signal for controlling the terminal 20, together with the display apparatus 100.

Hereinafter, operations of the processor 110 will be described in more detail.

The processor 110 may include, as shown in FIG. 3, a data collector 111, an analyzer 112, an additional information acquirer 113, a content arrangement device 114, a content decider 115, and a control signal generator 116. The data collector 111, the analyzer 112, the additional information acquirer 113, the content arrangement device 114, the content decider 115, and the control signal generator 116 may be logically or physically separated from one another.

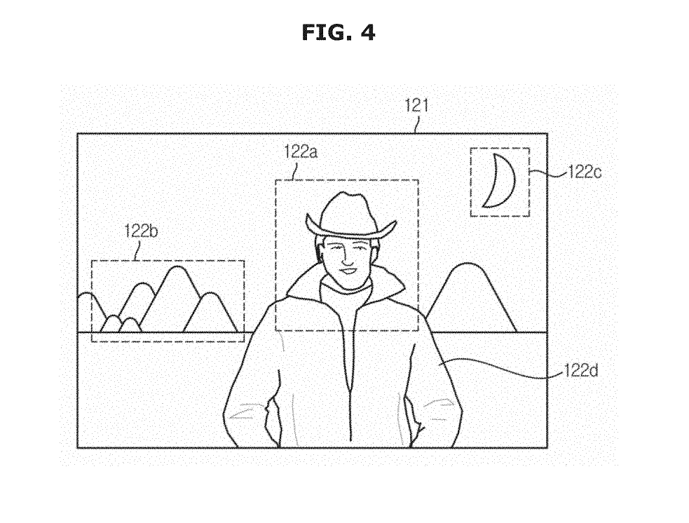

FIG. 4 shows an example of content that is to be analyzed.

The data collector 111 may collect data about content 121, as shown in FIG. 4. For example, the data collector 111 may acquire at least one image frame or sound data of the content 121 from the main memory 182, the auxiliary memory 183, or a buffer memory, and transfer the acquired data to the analyzer 112 for analyzing the data.

Herein, the content 121 may include, for example, an image that is currently being displayed by the display 185 of the display apparatus 100. Also, according to another example, the content 121 may include an image expected to be displayed, although it is currently not displayed, or an image selected by a user. More specifically, the content 121 may include, for example, broadcasting images reserved by a user or according to a pre-defined setting.

Also, the data collector 111 may further collect user-related data, for example, a user's preference or a user's use pattern of the display apparatus 100, in order to provide proper information to at least one user (for example, a viewer). More specifically, the data collector 111 may acquire all or a part of a use history (for example, information about a preferred channel, information about a main viewing time, or information about the installation or use state of an installed application) of the display apparatus 100 from the auxiliary memory 183, or may acquire additional information 122 or a virtual arrangement 120 acquired in advance from the auxiliary memory 183. Also, the data collector 111 may acquire user-related information 30 by receiving the user-related information 30 from the terminal 20 through the communicator 180 or 181. The acquired use history, the acquired additional information 122, the acquired virtual arrangement 120, or the acquired user-related information 30 may be transferred to the analyzer 112 to be analyzed.

The analyzer 112 may analyze data transferred from the data collector 111, and acquire the result of the analysis.

According to an embodiment, the analyzer 112 may include a content analyzer 112a and a user-related information analyzer 112b.

The content analyzer 112a may analyze the content 121 to extract information related to the content 121 from the content 121.

More specifically, for example, as shown in FIG. 4, when the content 121 is an image, the content analyzer 112a may extract objects 122a to 122d and/or a scene from the content 121 to extract information related to the content 121. Herein, the objects 122a to 122d may include a person, a place, an apparatus, and a thing such as a tool, etc. in the image. More specifically, for example, the objects 122a to 122d may include at least one person or a least one person's face displayed on the image, surrounding terrain or apparatuses 122b and 122c, and/or the person's clothes 122d. The scene may include the sight of an event that occurs in the image, such as, for example, a person's posture or gesture, a landscape, a relationship between the landscape and the person, etc. The content analyzer 112a may extract the objects 122a to 122d or the scene, and transfer the result of the extraction to the additional information acquirer 113.

According to an embodiment, the content analyzer 112a may adopt various algorithms for analyzing images to analyze the content 121. For example, the content analyzer 112a may analyze the content 121 based on at least one of machine learning, a region of interest (ROI) selection algorithm, and an image segmentation algorithm to extract information related to the content 121.

The machine learning may be to repeatedly apply a plurality of data to a predetermined algorithm (for example, the hidden Markov model or the artificial neural network) to learn the predetermined algorithm. More specifically, the algorithm is designed to output, when a predetermined value is input, a value corresponding to the input value, and may be implemented in the form of a program or database.

The content analyzer 112a may extract an object (for example, at least one person, the person's face 122a, or the terrain or things 122b and 122c) from the content 121, based on a pre-learned algorithm, and/or may compare objects extracted from individual frames to each other to extract a scene. In this case, the content analyzer 112a may additionally learn the learned algorithm based on the result of the extraction.

In order to apply the machine learning to the content 121, the content analyzer 112a may use at least one of a Deep Neural Network (DNN), a Convolutional Neural Network (CNN), a Recurrent Neural Network (RNN), a Deep Belief Network (DBN), and a Deep Q-Networks, alone or in combination.

The image segmentation is a process of segmenting an image into a plurality of segments (groups of pixels) to change the image to a format that can be easily analyzed. More specifically, the image segmentation means a method of classifying pixels in an image to groups of pixels sharing a predetermined characteristic, and analyzing the image based on the result of the classification. For example, the image segmentation may include various methods, such as a region growing method, an edge detection method, a clustering method, or a histogram-based segmentation method.

The content analyzer 112a may extract the above-described objects or scene from the content 121 through a predetermined image segmentation method.

The ROI selection algorithm is an algorithm of selecting a ROI in an image according to a predetermined definition, and extracting useful information such as an object in the ROI.

The content analyzer 112a may select a predetermined region (for example, a predetermined size of region including the center) of an image as a ROI. Alternatively, the content analyzer 112a may compare pixels in the image with respect to contrast or brightness of the pixels, detect at least one pixel (for example, at least one pixel having different contrast or brightness from the other pixels) whose contrast or brightness exceeds a predetermined value according to the result of the comparison, and set a region including most of the detected pixel as a ROI. After the ROI is selected, the content analyzer 112a may apply machine learning or image segmentation to the ROI, sequentially, to extract the above-described object or scene.

The user-related information analyzer 112b may analyze the user-related information 30 to acquire the result of the analysis. Herein, the user-related information 30 may include at least one of information (for example, the text information 31, the use history 33, and the content 35) transmitted from the terminal 20, and may also include information such as a use history of the display apparatus 100, stored in the auxiliary memory 183 of the display apparatus 100.

The user-related information analyzer 112b may analyze the user-related information 30, and decide the user's taste, hobby, preference, habit, area of concern, searching or buying pattern, etc., based on the result of the analysis.

The user-related information analyzer 112b may use at least one of the machine learning, the ROI selection algorithm, and the image segmentation algorithm, like the content analyzer 112a described above, in order to analyze the user-related information 30.

FIG. 5 shows an example of a virtual arrangement of content and additional information.

The result of the analysis by the analyzer 112 may be transferred to the additional information acquirer 113.

The additional information acquirer 113 may acquire one or two additional information 122 corresponding to the content 121, based on the result of the analysis by the analyzer 112.

The additional information 122 may be content related to the object or scene displayed in the content 121, and/or content matching with the user's taste or behavior with respect to the content 121, according to the result of the analysis by the analyzer 112. The additional information 122 may include a moving image, a still image, sound, voice, text such as a character or a symbol, a hyperlink, a graphical user interface providing a tool for calling the above-mentioned information or accessing a location at which the above-mentioned information is stored, or predetermined content that can be displayed by the display 185.

The additional information acquirer 113 may decide additional information 122 to be acquired and an additional information acquiring method corresponding to the additional information 122, based on the result of the analysis by the analyzer 112, and access the terminal 20, the auxiliary memory 183, and/or the content provider 200 based on the additional information acquiring method to acquire the additional information 122.

More specifically, the additional information acquirer 113 may use the machine learning, the ROI selection algorithm, and/or the image segmentation algorithm, in order to decide the additional information 122 to be acquired. For example, the additional information acquirer 113 may apply the result of the analysis by the content analyzer 112a and the result of the analysis by the user-related information analyzer 112b as input values to a predetermined, learned algorithm, and acquire results corresponding to the input values, thereby deciding the additional information 122 to be acquired. According to an embodiment, the additional information acquirer 113 may decide the additional information 122 to be acquired, using a predetermined mathematical formula defined by a weighted sum.

After the additional information 122 to be acquired is decided, the additional information acquirer 113 may decide an additional information acquiring method that is suitable for the additional information 122 to be acquired. The additional information acquirer 113 may decide an additional information acquiring method using a setting pre-defined by a user or a designer, the machine learning, the ROI selection algorithm, and/or the image segmentation algorithm.

The additional information acquiring method may include, for example, a method of deciding a search engine, a method of deciding a search word, a method of acquiring a pre-defined Internet address, and/or a method of detecting an application suitable for the result of the analysis from among applications stored in the display apparatus 100. The additional information acquiring method may include various methods capable of acquiring the additional information 122 related to the content 121, in addition to the above-mentioned methods.

After deciding the additional information acquiring method, the additional information acquirer 113 may acquire the additional information 122 through at least one of the communicator 180 or 181, the auxiliary memory 183, the input/output interface 184, the input device 187, the terminal 20, and the content provider 200. For example, the additional information acquirer 113 may search the auxiliary memory 183, access the external content provider 200 such as a web server 200b, search information (for example, a still image or a moving image) transferred from the terminal 20, and/or find data selected by a user or stored in a pre-defined another apparatus (for example, another home appliance that can communicate with the additional information acquirer 113), based on the result of the analysis by the analyzer 112, and finally acquire at least one additional information 122 corresponding to the content 121 based on the results of the searching and finding.

The acquired additional information 122 may be transferred to the content arrangement device 114.

According to an embodiment, the content arrangement device 114 may combine content 121 that is currently output or that is expected to be output with the additional information 122 acquired by the additional information acquirer 113, and arrange the combination in a predetermined form (or a predetermined pattern). For example, the content arrangement device 114 may arrange the content 121 and the at least one additional information 122 by calling a predetermined virtual arrangement 120 and disposing the content 121 and the at least one additional information 122 at individual locations of the virtual arrangement 120. Accordingly, the content arrangement device 114 may decide relative locations between the content 121 and the at least one additional information 122.

In this case, the content arrangement device 114 may arrange the content 121 and the additional information 122 based on a degree of association between the content 121 and the at least one additional information 122. For example, when the content 121 and the additional information 122 have a high degree of association with respect to their formats, content, or sources, the content arrangement device 114 may arrange the content 121 and the additional information 122 such that they are adjacent to each other. In contrast, when the content 121 and the additional information 122 have a low degree of association with respect to their formats, content, or sources, the content arrangement device 114 may place the content 121 and the additional information 122 such that they are distant from each other.

Also, the content arrangement device 114 may arrange the content 121 and the additional information 122 based on the characteristic of the additional information 122. For example, when the additional information 122 has relatively low quality (for example, low resolution), when the additional information 122 has a low frequency of reproduction, and/or when the content or title of the additional information 122 is not preferred by a viewer, the content arrangement device 114 may place the additional information 122 away from the content 121. In contrast, when the additional information 122 has high quality, when the additional information 122 has a high frequency of reproduction, and/or when the content or title of the additional information 122 is preferred by a viewer, the content arrangement device 114 may place the additional information 122 relatively close to the content 121.

Also, the content arrangement device 114 may arrange the content 121 and the additional information 122 based on classification of the additional information 122. For example, when the additional information 122 is classified to a text format of content or to pre-defined criterion such as an advertisement, the content arrangement device 114 may place the additional information 122 relatively farther away from the content 121.

According to an embodiment, as shown in FIG. 5, the virtual arrangement 120 may be in the shape of a band. In this case, the content 121 may be disposed in the center of the band, and in both directions (for example, left and right directions or up and down directions) from the content 121, the at least one additional information 122 (122a to 122d) may be arranged according to a pre-defined setting.

The at least one additional information 122a to 122d may be disposed at different locations according to the characteristics of the additional information 122a to 122d. For example, the additional information 122a and 122c that has been often or preferentially selected by a user may be disposed around the content 121, and the additional information 122b and 122d that has been infrequently selected by the user may be disposed relatively away from the content 121. More specifically, for example, additional information 122a related to smart phone functions may be disposed to the right of the content 121, and additional information 122b including an advertisement may be disposed to the right of the additional information 122a related to the smart phone functions, according to the user's taste or preference. Also, additional information 122c including a VOD application (or a web site) may be disposed to the left of the content 121, and additional information 122d including a web site screen of an Internet shopping mall may be disposed to the left of the additional information 122c for the VOD application. The arrangement of the at least one additional information 122a to 122d may be decided based on the result of the analysis by the analyzer 112. For example, the additional information 122 may be disposed based on the result of analysis according to the above-described machine learning.

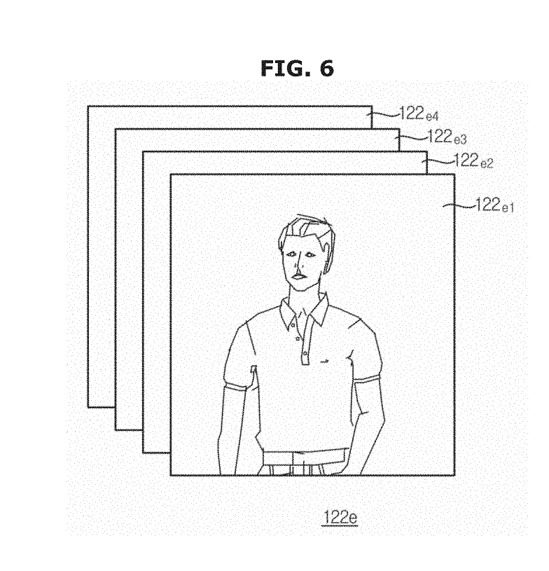

FIG. 6 shows an example of a screen on which a plurality of additional information is displayed.

Referring to FIG. 6, when the content arrangement device 114 (see FIG. 3) arranges the plurality of additional information 122a to 122d, the content arrangement device 114 may dispose related additional information 122e1 to 122e4 at the same location. The related additional information 122e1 to 122e4 may be the same kind, have been acquired from the same source (for example, the additional information 122e1 to 122e4 has been acquired from the same terminal 20 or the same web site), have the same meta data (for example, the same tag), or include content classified to a predetermined group according to pre-defined criterion.

According to an embodiment, the related additional information 122e1 to 122e4 may be displayed in such a way to overlap with each other. In this case, any one additional information 122e1 may be displayed as the entire image representing the corresponding content 122e1, and the other additional information 122e2 to 122e4 may be displayed as some parts (for example, the upper and left ends) of images representing the corresponding contents 122e2 to 122e4.

Also, according to another embodiment, the related additional information (not shown) may be displayed as a group of images (for example, thumbnail images) arranged in a predetermined pattern and having a relatively small size.

Also, the related additional information 122e1 to 122e4 may be arranged in various forms that can be considered by a designer.

The overlapping additional information 122e1 to 122e4 or a group of additional information consisting of relatively small sized images may replace any one of the above-described additional information 122a to 122d to be disposed in the virtual arrangement 120.

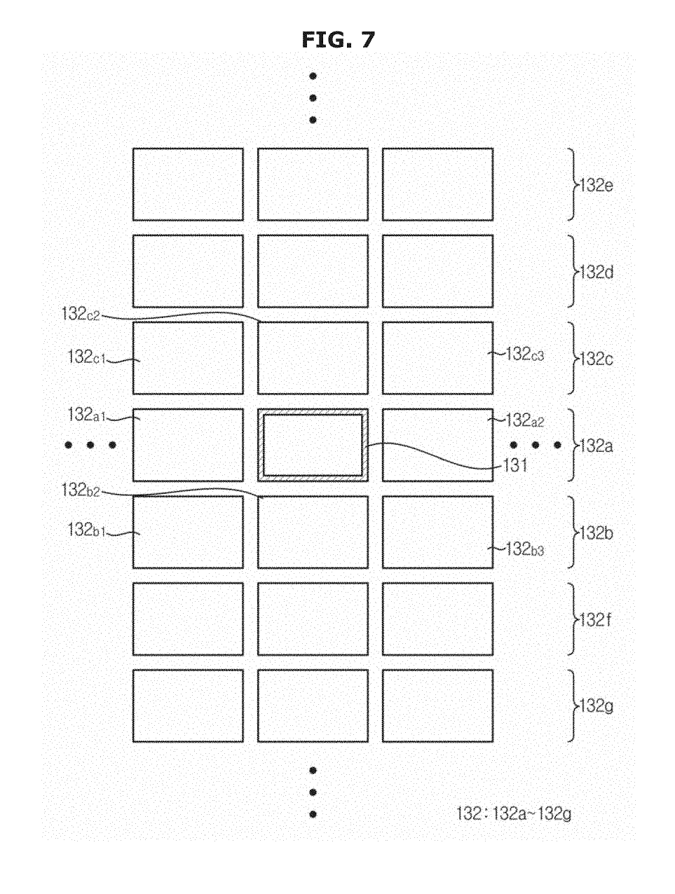

FIG. 7 shows another example of a virtual arrangement of content and additional information.

According to an embodiment, as shown in FIG. 7, a virtual arrangement 130 may be in the shape of a plane. More specifically, for example, the virtual arrangement 130 may be in the shape of a triangle, a quadrangle, or a rectangle. That is, content 131 and at least one additional information 132 (132a to 132g) may be arranged on a two-dimensional plane.

In this case, the content 131 may be disposed at the center of the plane, and in the left, right, up and down directions from the content 131, the at least one additional information 132 (132a to 132g) may be disposed according to a predetermined setting.

For example, video content 132a (132a1 and 132a2) related to the content 131 may be disposed to the left and right of the content 131. The video content 132a1 and 132a2 related to the content 131 may include video 35a stored in the terminal 20 and/or video transferred from the content provider 200, and may include streaming images or a graphical user interface for providing the streaming images.

Also, on the upper rows of a row on which the content 131 and the video content 132a1 and 132a2 related to the content 131 are arranged, content 132c related to searched shopping, content 132d related to searched text, and advertisement content 132e pre-defined or transferred from the content provider 200 may be disposed sequentially in this order in the up direction.

Also, on the lower rows of the row on which the content 131 and the video content 132a1 and 132a2 related to the content 131 are arranged, content 132b, 132f, and 132g acquired from the terminal 20 may be disposed sequentially in this order in the down direction. For example, when content is acquired from a plurality of terminals 20, content 132b of any one terminal 20 may be disposed on the relatively upper row 132b, and content 132f and 132g of the other terminals 20 may be disposed sequentially on the relatively lower rows 132f and 132g, respectively, according to a user's selection or a pre-defined setting.

The above-described method of arranging the content 131 and the additional information 132 may be an example, and a method of arranging the content 131 and the additional information 132 is not limited to this. A designer may dispose a plurality of additional information 132 in a planar, virtual arrangement 130 using various methods, in consideration of a user's taste, convenience, importance of the additional information 132, etc.

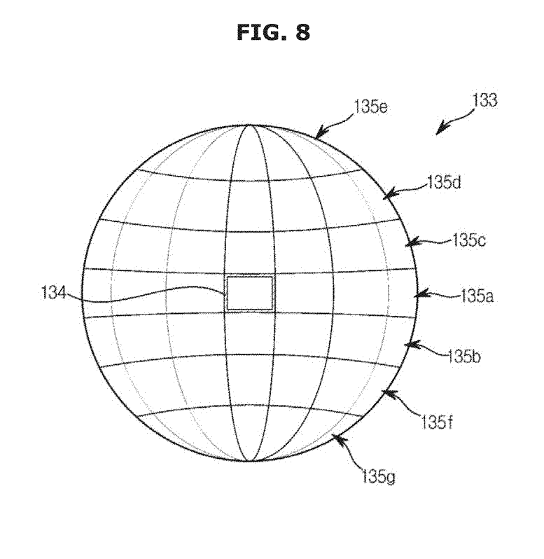

FIG. 8 shows another example of a virtual arrangement of content and additional information.

As shown in FIG. 8, according to an embodiment, a virtual arrangement 133 may be in the shape of a sphere or hemisphere. That is, content 134 and at least one additional information 135 (132a to 132g) may be disposed at predetermined areas of a three-dimensional sphere or hemisphere.

In this case, the content 134 may be disposed in an area set to a reference area by a user or a designer among a plurality of areas of the sphere or hemisphere, and the at least one additional information 135 (135a to 135g) may be disposed in the left, right, up, and down directions from the content 134.

For example, like the planar, virtual arrangement 130, video content 135a related to the content 134 may be disposed to the left and right of the content 134, and on the upper row of a row on which the content 134 is disposed, content 135c related to shopping may be disposed. On the upper row of the row on which the content 135c related to shopping is disposed, content 135d related to searched text may be disposed, and on the upper row of the row on which the content 135d related to searched text is disposed, advertisement content 135e may be disposed. Also, on the lower rows of the row on which the content 134 is disposed, content 135b, 135f, and 135g acquired from the terminal 20 may be disposed according to a user's selection or a pre-defined setting.

The above-described method of arranging the content 134 and the additional information 135 on the sphere or hemisphere may be an example, and a method of arranging the content 134 and the additional information 135 is not limited to this. A designer may dispose a plurality of additional information 135 in the virtual arrangement 133 which is in the shape of a sphere or hemisphere, using various methods according to an arbitrary selection.

When the content 134 and the at least one additional information 135a to 135g are arranged on the sphere or hemisphere, as described above, a relatively larger number of additional information 135a may be disposed on the row on which the content 134 is disposed, and around both poles, a relatively smaller number of additional information 135e and 135g may be disposed. Also, when the virtual arrangement 133 is in the shape of a sphere, the content 134 and the at least one additional information 135a to 135g may exist in all directions from the center of the sphere.

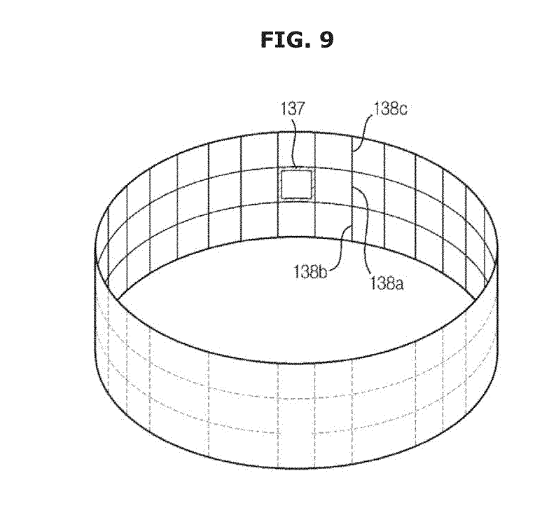

FIG. 9 shows another example of a virtual arrangement of content and additional information.

According to an embodiment, as shown in FIG. 9, a virtual arrangement 136 may be in the shape of a cylinder having a plurality of rows. In other words, an arrangement of content 137 and at least one additional information 138 (138a to 138c) may be in the shape of a cylinder including a plurality of rows. Herein, the number of the rows may be two, three as shown in FIG. 9, four, or more.

In this case, the content 137 may be located at a predetermined point, and at least one additional information 138a may be disposed in the left and right directions from the content 137. Also, on the upper and lower row(s) of the row on which the content 137 is disposed, at least one other additional information 138b and 138c may be disposed.

As such, when the content 137 and the additional information 138 are arranged in the shape of a cylinder, the content 137 and the additional information 138 may surround the center of the cylinder at 360 degrees. Accordingly, when the additional information 138a is called sequentially in the left or right direction from the content 137 according to a command including the left or right direction, as described later, the content 137 may be finally again called.

So far, various examples of the virtual arrangements 120, 130, 133, and 136 have been described with reference to FIGS. 5 to 9. However, the virtual arrangements 120, 130, 133, and 136 are examples, and virtual arrangements according to embodiments of the present disclosure are not limited to these. A designer may define and decide various virtual arrangements in consideration of various purposes or effects, such as the characteristics of content, a user's convenience, convenience of design, etc. The defined and decided virtual arrangements may also be examples of the virtual arrangements 120, 130, 133, and 136 described above.

The content decider 115 may decide content that is to be displayed on the display 185. More specifically, the content decider 115 may decide an image being currently displayed on the display 185 as an image to be displayed, or may decide another image that is to be displayed instead of an image being currently displayed on the display 185, according to a received user command. The image being currently displayed on the display 185 may include, for example, any one of the content 121, 131, 134, and 137 and the at least one additional information 122, 132, 135, and 138. The other image that is to be displayed may include any one of the at least one additional information 122, 132, 135, and 138, when the image being currently displayed is the content 121, 131, 134, and 137. When the image being currently displayed is the at least one additional information 122, 132, 135, and 138, the other image that is to be displayed may include any one of the content 121, 131, 134, and 137 and the at least one additional information 122, 132, 135, and 138.

The content decider 115 may decide content that is to be displayed on the display 185, using at least one of the above-described virtual arrangements 120, 130, 133, and 136.

For example, the content decider 115 may decide content that is to be displayed on the display 185, that is, any one of the content 121, 131, 134, and 137 and the at least one additional information 122, 132, 135, and 138, using the virtual arrangement 120, 130, 133, or 136, according to a user command input through the remote controller 10.

After content that is to be displayed on the display 185 is decided, the content decider 115 may transfer the content to the control signal generator 116. The control signal generator 116 may generate a control signal for the display 185 (116a of FIG. 3) and/or generate a control signal for the sound output device 186 (116b of FIG. 3), according to the decided content. According to an embodiment, the control signal generator 116 may generate a control signal that is to be transferred to the terminal 20, according to the decided content (116c of FIG. 3), and transfer the control signal to the terminal 20 through the communicator 180 or 181.

Hereinafter, an example of a process for changing content displayed using the virtual arrangement 120, 130, 133, or 136 to decided content will be described.

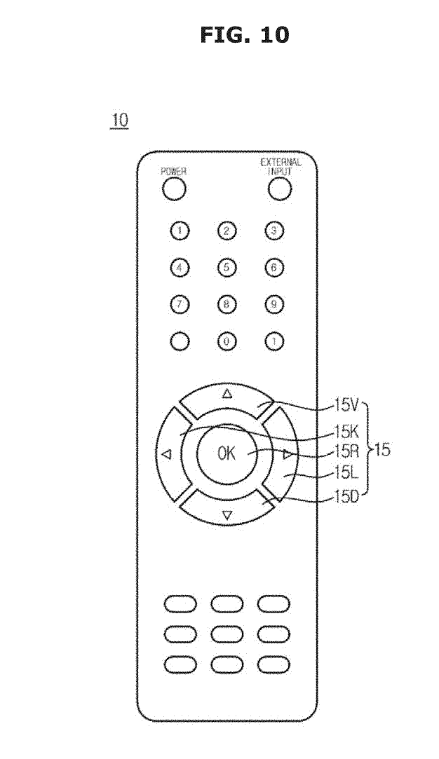

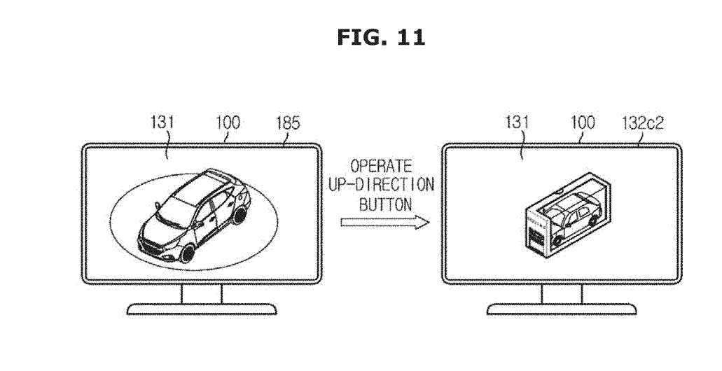

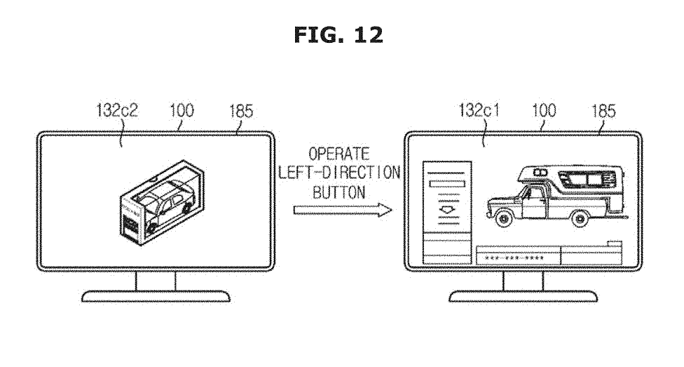

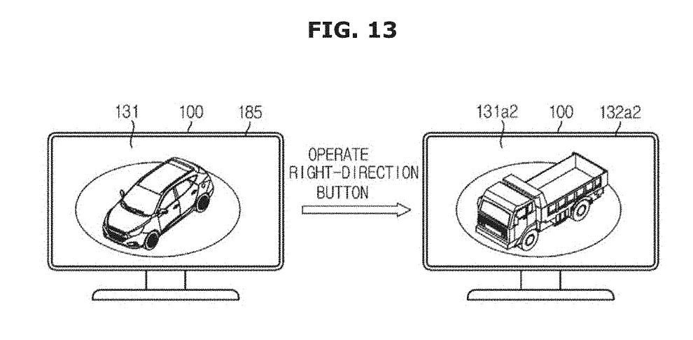

FIG. 10 shows the outer appearance of an example of a remote controller, FIG. 11 shows an example of additional information displayed according to an operation of a remote controller, FIG. 12 shows another example of additional information displayed according to an operation of a remote controller, and FIG. 13 shows another example of additional information displayed according to an operation of a remote controller.

When a user operates the remote controller 10 to input a user command, the content decider 115 may decide content 121, 122, 131, 132, 134, 135, 137, or 138 that is to be displayed on the display 185, based on the user command received through the short-range communicator 180, for example, the infrared communicator 180a.

The remote controller 10 may include, as shown in FIG. 10, an input device 15 for receiving a user command. Herein, the input device 15 may be implemented with at least one physical button, a touch pad, a touch screen, a trackball, or a track pad. Also, the input device 15 may be implemented with a gyro sensor for sensing orientation of the remote controller 10.

The input device 15 may receive a command for at least one direction. For example, when the input device 15 is implemented as physical buttons, the input device 15 may include an up-direction button 15V for receiving an up-direction selection command, a left-direction button 15K for receiving a left-direction selection command, a right-direction button 15L for receiving a right-direction selection command, and a down-direction button 15D for receiving a down-direction selection command. The input device 15 may further include a confirm button 15R for confirming a predetermined direction selection command.

When a user presses any one of the direction buttons 15V, 15L, 15K, and 15D or presses any one of the direction buttons 15V, 15L, 15K, and 15D and the confirm button 15R sequentially, a user command including a predetermined direction may be input to the remote controller 10. The remote controller 10 may transfer the user command including the predetermined direction to the display apparatus 100, and the content decider 115 of the display apparatus 100 may decide content that is to be displayed using a predetermined virtual arrangement 120, 130, 133, or 136 based on the predetermined direction included in the user command.

Hereinafter, for convenience of description, a process of deciding content will be described based on an example in which the virtual arrangement 130 is a rectangular plane. However, the process of deciding content, which will be described below, may be applied to cases in which the virtual arrangements 120, 133, and 136 have other forms, in the same manner or through some modifications.

For example, referring to FIGS. 7 and 11, when a user presses the up-direction button 15V in the state in which the display 185 of the display 100 displays the content 131, the content decider 115 may receive a user command including an up direction, and decide additional information positioned at a location corresponding to the up direction, that is, additional information 132c2 located immediately above the content 131, as content that is to be displayed. Information about the decided content may be transferred to the control signal generator 116, and the display 185 may display the additional information 132c2 located immediately above the content 131, under the control of the control signal generator 116.

When the user presses the left-direction button 15K in the state in which the additional information 132c2 located immediately above the content 131 is displayed on the display 185, the content decider 115 may receive a user command including a left direction, and decide additional information positioned at a location corresponding to the left direction, that is, content 132c1 located to the left of the additional information 132c2, as content that is to be displayed. Likewise, information about the decided content may be transferred to the control signal generator 116, and the display 185 may display the decided content 132c1 under the control of the control signal generator 116, as shown in FIG. 12.

As shown in FIG. 13, when a user presses the right-direction button 15L in the state in which the display 185 of the display 100 displays the content 131, the content decider 115 may receive a user command including a right direction through the infrared communicator 180a, and decide content positioned at a location corresponding to the right of the content 131, as content that is to be displayed. The control signal generator 116 may generate a control signal for the display 185 according to the result of the decision by the content decider 115, and the display 185 may receive additional information 132a2 located to the right of the content 131 in response to the control signal from the control signal generator 116.

In addition, according to which one of the physical buttons 15V, 15L, 15K, and 15D is selected by a user, another content positioned at the corresponding location with respect to displayed content may be displayed.

So far, the process of deciding content according to a direction has been described based on an embodiment of operating the physical buttons 15V, 15L, 15R, 15D, and 15K provided in the remote controller 10 to input a user command including a direction. However, a method of inputting a user command including a direction to the remote controller 10 is not limited to this. For example, a user may input a user command including a direction to the remote controller 10 by applying a touch gesture (a swipe gesture or a drag gesture) having directivity to a touch pad or a touch screen provided in the remote controller 10, by panning or tilting the remote controller 10 including a gyro sensor in a predetermined direction, and/or by rotating a trackball provided in the remote controller 10 in a predetermined direction. As such, when a user command is input to the remote controller 10, the display apparatus 100 may be controlled as shown in FIGS. 11 to 13.

Hereinafter, an example of an interactive operation between the display apparatus 100 and the terminal 20 will be described.

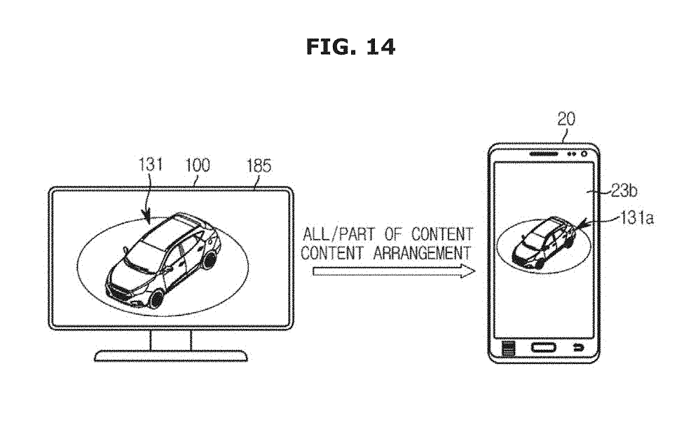

FIG. 14 shows an example in which a terminal displays content in correspondence to a display apparatus.

Referring to FIGS. 2, 3, and 14, after content 131 that is to be displayed is decided by the content decider 115, the control signal generator 116 may control at least one of the display 185 and the sound output device 186 in response to the decision by the content decider 185 to display the decided content 131 on the display 185 or to output the decided content 131 through the sound output device 186 (116a and 116b). In this case, the control signal generator 116 may further generate a control signal for the terminal 20 according to a user's selection or a predefined setting (116c).

For example, the control signal generator 116 may generate a control signal for causing the terminal 20 to display the decided content 131, and transmit the control signal to the terminal 20 through the communicator 180 or 181. In this case, the communicator 180 or 181 may transmit the control signal generated by the control signal generator 116, and the content 131 decided by the content decider 115 to the terminal 20, and the communicator 22 of the terminal 20 may receive content 131a and the control signal transmitted from the display apparatus 100. The processor 21 may generate a control signal for the display 23b in response to the received control signal, and the display 23b may output the received content 131a. Accordingly, as shown in FIG. 14, the content 131 and 131a which is the substantially same content may be respectively output to the outside by the display apparatus 100 and the terminal 20, simultaneously or within the range of a temporal error.

When the content 131 and 131a includes an image, an image 131a displayed by the terminal 20 may be an image of the same size, resolution, and compression method as an image 131 displayed by the display apparatus 100. Alternatively, according to an embodiment, the image 131a displayed by the terminal 20 may be an image of a size, resolution, or compression method that is different from that of the image 131 displayed by the display apparatus 100. For example, the terminal 20 such as a smart phone may have lower performance than the display apparatus 100 such as a digital television, and output a screen of a lower resolution than the display 23b. In this case, in order for the terminal 20 to stably reproduce the received image, the processor 110 of the display apparatus 100 may further perform at least one of adjusting the size of the image 131, adjusting the resolution of the image 131, and re-compressing the image 131, before transmitting the image 131.

The communicator 180 or 181 may transmit a virtual arrangement 120, 130, 133, or 136 decided by the content arrangement device 114, together with the content decided by the content decider 115, to the terminal 20, as necessary. The virtual arrangement 120, 130, 133, or 136 received by the terminal 20 may be used for a control for changing the content of the display apparatus 100 through the terminal 20. This will be described later.

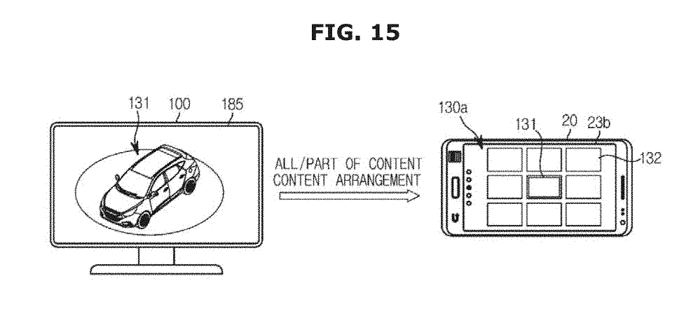

FIG. 15 shows another example in which a terminal displays content in correspondence to a display apparatus.

Referring to FIG. 15, after content that is to be displayed is decided by the content decider 115, the control signal generator 116 may further generate a control signal for displaying content according to the virtual arrangement 120, 130, 133, or 136, instead of content decided for the terminal 20 (116c). In this case, the communicator 180 or 181 may transmit the control signal generated by the control signal generator 116 and the virtual arrangement 120, 130, 133, or 136 decided by the content arrangement device 114 to the terminal 20. The virtual arrangement 120, 130, 133, or 136 may be all or a part of already acquired virtual arrangements 120, 130, 133, and 136. The communicator 22 of the terminal 20 may receive the control signal and the virtual arrangement 120, 130, 133, or 136, and the processor 21 may generate a control signal for the display 23b in response to the control signal. The display 23b may output an image 130a corresponding to the virtual arrangement 120, 130, 133, or 136. When all of the virtual arrangements 120, 130, 133, and 136 are received, the display 23b may display all or a part of the virtual arrangements 120, 130, 133, and 136. When the display 23b displays a part of the virtual arrangements 120, 130, 133, and 136, the display 23b may display additional information 132 around the content 131 with the content 131 as the center. When a part of the virtual arrangements 120, 130, 133, and 136 is received, the display 23b may display the received part of the virtual arrangement 120, 130, 133, and 136.

When the virtual arrangements 120, 130, 133, and 136 are transmitted, the processor 110 of the display apparatus 100 may further perform at least one of adjusting the size of the image 131, adjusting the resolution of the image 131, and re-compressing the image 131, before transmitting the image 131, as necessary.

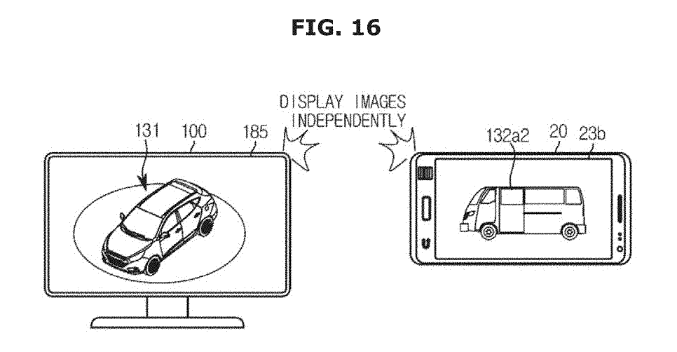

FIG. 16 shows another example in which a terminal displays content in correspondence to a display apparatus.

As shown in FIG. 16, when the terminal 20 receives a control signal, content 131 decided by the content decider 115, and a virtual arrangement 120, 130, 133, or 136 decided by the content arrangement device 114, the display 185 of the display apparatus 100 and the display 23b of the terminal 20 may display the substantially same content 131 and 131a.

In this case, according to an embodiment, after the terminal 20 receives the control signal, the content 131, and the virtual arrangement 120, 130, 133, or 136, the terminal 20 may operate independently from the display apparatus 100. In other words, as shown in FIG. 16, when the display apparatus 100 displays predetermined content, for example, the content 131, a user may operate the terminal 20 to change the displayed content to other content. For example, when the user applies a touch gesture having directivity, such as a swipe gesture, to the user interface 23 of the terminal 20, the processor 21 of the terminal 20 may select other content 132a2 corresponding to the direction of the touch gesture with respect to content 131a being currently output, using the virtual arrangement 120, 130, 133, or 136, and decide the content 132a2. The processor 21 may transfer a command for displaying the selected content 132a2 to the display 23b, and the display 23b may display the selected content 132a2 in response to the command. In this case, information about the change to the content 132a2 or information about the newly decided content 132a2 may be not transferred to the display apparatus 100. Accordingly, the display apparatus 100 and the terminal 20 may display the different content 131 and 132a2.

Hereinafter, an embodiment of a process of controlling the display apparatus 100 through the terminal 20 will be described.

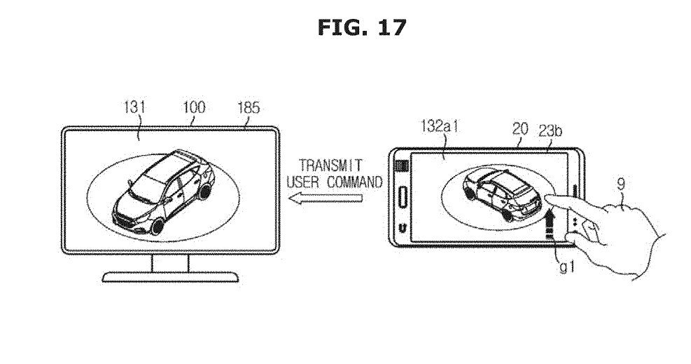

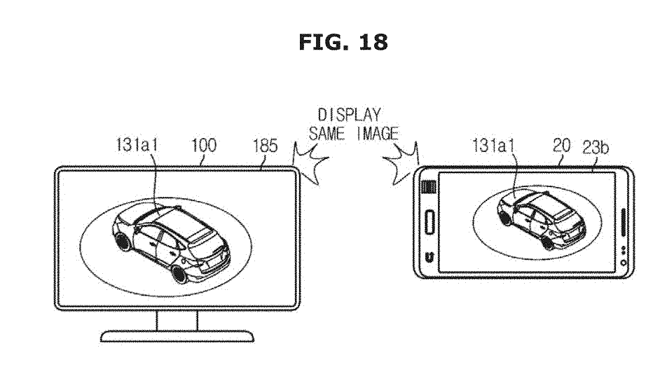

FIG. 17 is a first view showing an example of controlling a display apparatus through a terminal, and FIG. 18 is a second view showing an example of controlling a display apparatus through a terminal.

As shown in FIG. 17, when the terminal 20 receives a control signal, decided content 131, and a virtual arrangement 120, 130, 133, or 136, and the display 23b displays the decided content 131, the display 185 of the display apparatus 100 and the display 23b of the terminal 20 may display the substantially same content 131 and 131a.

In this case, a user may input a user command including a direction to the terminal 20 according to his/her selection or a pre-defined setting to change the content 131 displayed on the display 185 of the display apparatus 100.

More specifically, as shown in FIG. 17, when a user uses a predetermined object 9 (for example, a finger or a stylus pen) to apply a swipe gesture g1 in a predetermined direction (for example, a up direction) on a touch screen of the terminal 20, the processor 21 of the terminal 20 may read the virtual arrangement 120, 130, 133, or 136 to decide content 131a1 located in a direction corresponding to the direction of the swipe gesture g1 with respect to the content 131 being currently displayed. Successively, the processor 21 may control the display 23b to display the decided content 131a1. Also, the processor 21 may generate a control signal corresponding to the user command (that is, the swipe gesture g1 of the up direction) and/or a control signal corresponding to the decided content 131a1, and transmit the control signal to the display apparatus 100 through the communicator 22.

The display apparatus 100 may change the content 131 displayed by the display 185 to the decided content 131a1 based on the received control signal. More specifically, for example, the processor 110 of the display apparatus 100 may acquire the user command from the control signal, decide the content 131a1 in correspondence to the user command, and generate a control signal for the display 185 and/or the sound output device 186 based on the decided content 131a1. According to another example, the processor 110 of the display apparatus 100 may acquire information about the content 131a1 decided from the control signal, and generate a control signal for the display 185 and/or the sound output device 186 based on the information about the content 131a1.

Accordingly, the display 185 and/or the sound output device 186 of the display apparatus 100 may output the substantially same content 131a1 as that displayed on the display 23b of the terminal 20 to the outside. Therefore, the display apparatus 100 may be controllable according to an operation of the terminal 20.

FIG. 19 shows an example of receiving a symbol through a terminal.

When the display apparatus 100 outputs content 121, 131, 134, or 137 and/or additional information 122, 132, 135, or 138 to provide them to a user, the display apparatus 100 may need to receive a character, a sign, a figure, or other various symbols (hereinafter, also referred to as a character, etc.) from the user. In this case, the display apparatus 100 may receive the character, etc. through the remote controller 10, a separate keyboard, etc., or through the terminal 20 as shown in FIG. 19.

When the display apparatus 100 receives the character, etc. through the terminal 20, the processor 110 may determine whether the content 121, 131, 134, or 137 and/or the additional information 122, 132, 135, or 138 being currently output or expected to be output immediately needs an input of a character, etc. or can receive a character, etc. For example, the processor 110 may determine whether the content 121, 131, 134, or 137 and/or the additional information 122, 132, 135, or 138 includes a character input window, such as a message input window or a search window.

When the processor 110 determines that the content 121, 131, 134, or 137 and/or the additional information 122, 132, 135, or 138 needs an input of a character, etc. or can receive a character, etc., the control signal generator 116 of the processor 110 may generate a control signal for requesting the terminal 20 to change to a ready state for allowing a user to input a character, etc. (116c). The control signal may be transferred to the processor 21 of the terminal 20 through the communicators 180, 181, and 22 of the display apparatus 100 and the terminal 20.

The processor 21 of the terminal 20 may determine whether the terminal 20 can change to the ready state for allowing the user to input the character, etc., and transfer the result of the determination to the display apparatus 100. When the processor 21 determines that the terminal 20 can change to the ready state for allowing the user to input the character, etc., the processor 21 may control the display 23b to display a virtual keyboard 25b1 for allowing a user to input a character, etc., and wait the user's input of inputting a character, etc. In this case, the display 23b may display the virtual keyboard 25b1 in a predetermined area, and according to an embodiment, the display 23b may display the virtual keyboard 25b1 together with content 133 being currently displayed or overlapping with the content 133 being currently displayed.

When the user inputs a character, etc., the processor 21 may transmit the character, etc. to the display apparatus 100. On the contrary, when the processor 21 determines that the terminal 20 cannot change to the ready state for allowing the user to input the character, etc., the processor 21 may perform no operation related to an input of inputting a character, etc. and the processor 110 of the display apparatus 100 may cancel a process prepared to allow a user to input a character, etc., and/or control the display 185 to output an error message to the outside, as necessary.

Accordingly, the display apparatus 100 may receive a required character, etc. from the user.

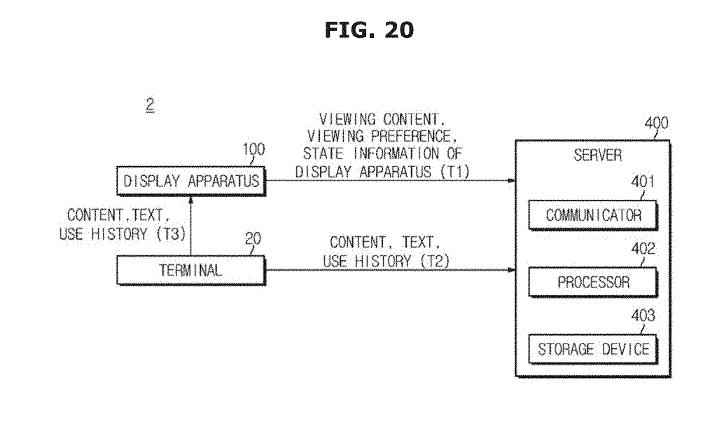

Hereinafter, another embodiment of display apparatus control system 2 will be described with reference to FIG. 20.

FIG. 20 shows another embodiment of entire system.

Referring to FIG. 20, the display apparatus control system 2 according to an embodiment may include a terminal 20, a display apparatus 100, and a server 400 for supporting operations of the display apparatus 100.

The terminal 20 may be connected to the display apparatus 100 in such a way to be communicable with the display apparatus 100. According to an embodiment, the terminal 20 may be connected to the server 400 in such a way to be communicable with the server 400.

When the terminal 20 is connected to the display apparatus 100 in such a way to be communicable with the display apparatus 100, the terminal 20 may transmit stored user-related information 30 (for example, content, text, and/or various use histories of the terminal 20) to the display apparatus 100 in response to a request from the display apparatus 100 (t3). According to an embodiment, the terminal 20 may receive a request for transmitting the user-related information 30 to the display apparatus 100 from the server 400.

Also, when the terminal 20 is connected to the sever 400 in such a way to be communicable with the server 400, the terminal 20 may transmit the user-related information 30 (for example, stored content, text, and/or various use histories of the terminal 20) to the sever 400 in response to a request from the server 400 or a request from the display apparatus 100 (t2).

The display apparatus 100 may collect information about content 121, for example, content which a user is watching, information about a preferred channel, information (for example, an installation state, use time, etc. of an application) about a current state of the display apparatus 100, as described above, and receive user-related data (that is, the user-related information 30) from the terminal 20, as necessary. The display apparatus 100 may transmit the information about the content 121 to the server (t1), and transmit the user-related information 30 received from the terminal 20 to the server 400, as necessary. When the terminal 20 has transmitted the user-related information 30 to the sever 400, the display apparatus 100 may not transmit the user-related information 30 to the sever 400.

The server 400 may include a communicator 401 for communicating with at least one of the display apparatus 100 and the terminal 20, a processor 402 for controlling overall operations of the server 400, and a storage device 403 for temporarily or non-temporarily storing various applications or data required for operations of the server 400.

The communicator 401 may receive the information about the content 121 and the user-related information 30 from at least one of the display apparatus 100 and the terminal 20, and transfer the information about the content 121 and the user-related information 30 to the processor 402.

The processor 402 may analyze the content 121 and/or the user-related information 30 by using the same method which the analyzer 112 of the display apparatus 100 uses or by partially modifying the method which the analyzer 112 of the display apparatus 100 uses, based on the information about the content 121 and the user-related information 30. The processor 402 may analyze the content 121 and the user-related information 30 using, for example, the machine learning, the ROI selection algorithm, or the image segmentation.

Sequentially, the processor 402 may decide additional information 122 to be acquired and/or a method of acquiring the additional information 122 based on the results of the analysis on the content 121 and the user-related information 30.

After deciding the additional information 122 to be acquired and/or the method of acquiring the additional information 122, the processor 402 may transmit the additional information 122 to be acquired and/or the method of acquiring the additional information 122 to the display apparatus 100 through the communicator 401. The display apparatus 100 may acquire the additional information 122 by receiving the additional information 122 to be acquired and/or the method of acquiring the additional information 122, arrange the acquired additional information 122 and the content 121 according to pre-defined criterion, and decide content that is to be output to the outside based on a user command and the result of the arrangement. The decided content may be displayed on the display 185 of the display apparatus 100 as described above, or may be displayed on the display 23b of the terminal 20, as necessary.

A method of analyzing the content 121 and the user-related information 30, a method of deciding the additional information 122 that is to be acquired, a method of deciding the method of acquiring the additional information 122, and operations of the terminal 20 and the display apparatus 100 have been described above, and accordingly, further descriptions thereof will be omitted.

According to the display apparatus control system 2 according to the other embodiment as described above, a part of the functions of the display apparatus 100 may be performed by the server 400. Accordingly, the display apparatus 100 may not need to perform machine learning consuming a large amount of resources or may perform a small amount of machine learning so that the display apparatus 100 can perform various operations more quickly.

When there are a plurality of display apparatuses 100, the server 400 may receive content 121 and user-related information 30 from the respective display apparatuses 100. In this case, in order to decide additional information 122 that is to be acquired and/or a method of acquiring the additional information 122 for any one of the plurality of display apparatuses 100, the server 400 may use the content 122 and the user-related information 30 transferred from the display apparatus 100, or may further use the content 122 or the user-related information 30 transferred from another display apparatus 100 according to an embodiment.

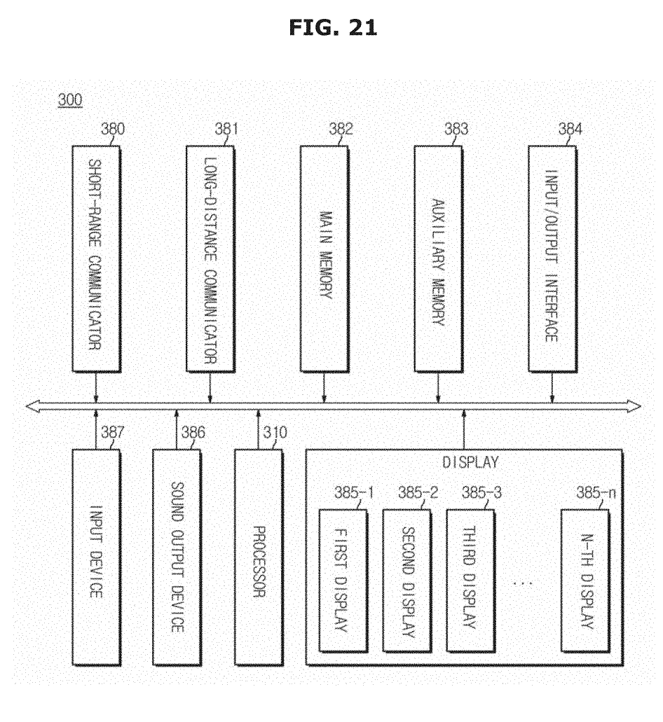

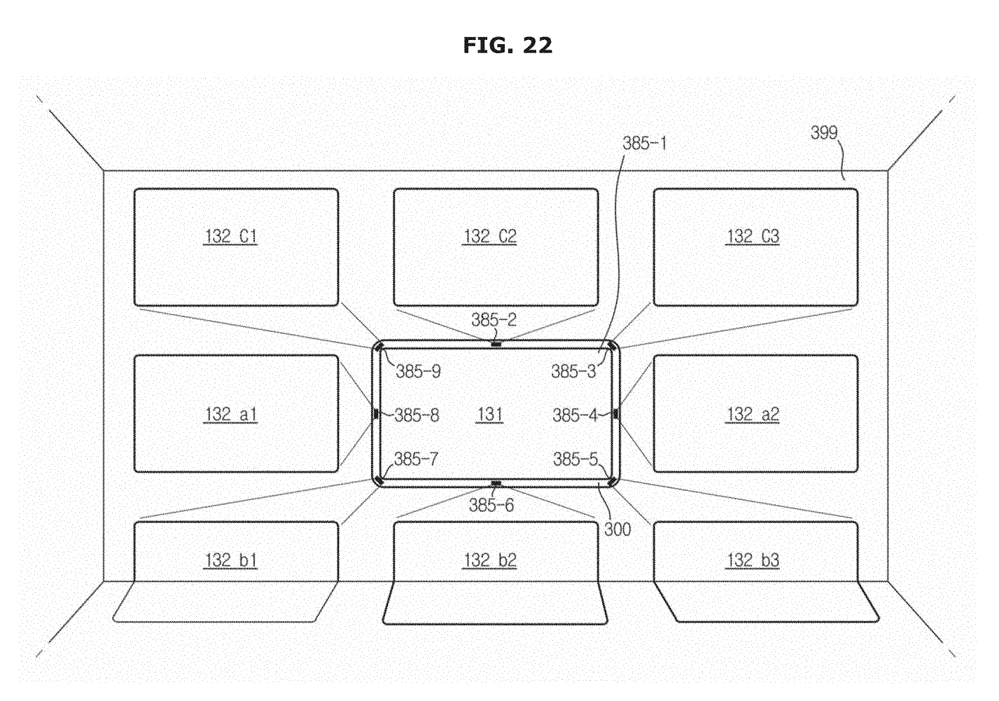

Hereinafter, another embodiment of the display apparatus 100 will be described with reference to FIGS. 21 and 22.

FIG. 21 shows another embodiment of a display apparatus, and FIG. 22 shows an example of another embodiment of a display apparatus.

As shown in FIG. 21, a display apparatus 300 according to another embodiment may include a processor 310, a short-range communicator 380, a long-distance communicator 381, main memory 382, auxiliary memory 383, an input/output interface 384, a sound output device 386, and an input device 387. According to an embodiment, at least one of the above-mentioned components may be omitted.

The processor 310, the short-range communicator 380, the long-distance communicator 381, the main memory 382, the auxiliary memory 383, the input/output interface 384, the sound output device 386, and the input device 387 may have the substantially same structures, functions, and operations as the processor 110, the short-range communicator 180, the long-distance communicator 181, the main memory 182, the auxiliary memory 183, the input/output interface 184, the sound output device 186, and the input device 187 as described above, and accordingly, detailed descriptions thereof will be omitted.

As shown in FIGS. 21 and 22, the display 385 may include a plurality of displays 385-1 to 385-n (hereinafter, referred to as first to n-th displays) according to an embodiment. The display 385 may include a predetermined number of displays 385-1 to 385-n according to a designer's selection. For example, the display 385 may include nine displays 385-1 to 385-9 as shown in FIG. 22. However, this is an example, and the number of the displays 385-1 to 385-n is not limited. That is, the display apparatus 300 may include a predetermined number of displays 385-1 to 385-n that are less than or more than nine, according to a designer's selection.

According to an embodiment, the first display 385-1 may be implemented with a LED display panel, a LCD panel, or a CRT installed in the display apparatus 300. Also, the first display 385-1 may be a projector. The projector may be a short throw projector capable of performing short-distance projection.

Another display, for example, the second to ninth displays 385-2 to 385-9 may be implemented with a display panel, a CRT, and/or a projector. In this case, the second to ninth displays 385-2 to 385-9 may be implemented with the same kind of apparatuses or different kinds of apparatuses.

The second to ninth displays 385-2 to 385-9 may be integrated into the display apparatus 300 or detachably installed in the display apparatus 300, as necessary.

The other displays, for example, the second to ninth displays 385-2 to 385-9 may be the same as the first display 385-1 or different from the first display 385-1 as shown in FIG. 22. For example, the first display 385-1 may be implemented with a display panel, and the second to ninth displays 385-2 to 385-9 may be implemented with a projector of displaying images by irradiating a beam to a short distance. When the second to ninth displays 385-2 to 385-9 are implemented with a projector, images may appear on a wall 399 around the display apparatus 300.

The plurality of displays 385-1 to 385-n may respectively provide images visually for a user. In this case, the respective displays 385-1 to 385-n may display at least one of the above-described content 121, 131, 134 and 137 (hereinafter, simply referred to as content 131) and the additional information 122, 132, 135, and 138 (hereinafter, simply referred to as additional information 132) under the control of the processor 310.

For example, when the content 131 and the additional information 132 are arranged in a predetermined virtual arrangement 120, 130, 133, or 136, as described above, any one display, for example, the first display 385-1 may be controlled to display the content 131, and the other displays, for example, the second to ninth displays 385-2 to 385-9 may be controlled to display the additional information 132 disposed at locations corresponding to locations at which images are displayed by the second to ninth displays 385-2 to 385-9. More specifically, when the first display 385-1 displays the content 131, the second to ninth displays 385-2 to 385-9 may display additional information 132 disposed at locations corresponding to locations at which images are respectively displayed among a plurality of additional information 132 in a virtual arrangement 120, 130, 133, or 136 created by the processor 300.

In this case, the second to ninth displays 385-2 to 385-9 may display additional information 132 disposed at the corresponding locations among additional information 132 disposed around the content 131 displayed by the first display 385-1. More specifically, for example, as shown in FIG. 22, the first display 385-1 may be controlled to display the content 131, the second display 385-2 for displaying an image in a up direction from the first display 385-1 may be controlled to display additional information (132c2 of FIGS. 7 and 22) located in the up direction from the content 131, and the third display 385-3 for displaying an image in a right and up direction from the first display 385-1 may be controlled to display additional information 132c3 located in the right and up direction from the content 131. Also, the fourth display 385-4 for displaying an image in a right direction from the first display 385-1 may be controlled to display additional information 132a2 located in the right direction from the content 131, the fifth display 385-5 for displaying an image in a right and down direction from the first display 385-1 may be controlled to display additional information 132b3 located in the right and down direction from the content 131, and the sixth display 385-6 for displaying an image in a down direction from the first display 385-1 may be controlled to display additional information 132b2 located in the down direction from the content 131. Also, the seventh display 385-7 for displaying an image in a left and down direction from the first display 385-1 may be controlled to display additional information 132b1 located in the left and down direction from the content 131, the eighth display 385-8 for displaying an image in a left direction from the first display 385-1 may be controlled to display additional information 132a1 located in the left direction from the content 131, and the ninth display 385-9 for displaying an image in a left and up direction from the first display 385-1 may be controlled to display additional information 132c1 located in the left and up direction from the content 131.

When the first display 385-1 displays any one additional information 132, instead of the content 131, the second to ninth displays 385-2 to 385-9 may display additional information 132 and/or content 131 located around the additional information 132 displayed by the first display 385-1.

According to a situation, all of the first to ninth displays 385-1 to 385-9 may display the additional information 132, or any one of the first to ninth displays 385-1 to 385-9 may display the content 131.

When a user inputs a command (for example, when a user presses a direction key or makes a touch gesture having directivity) having a direction through the input device 387, information displayed on at least one of the first to ninth displays 385-1 to 385-9 may change. For example, when a command indicating a up direction is input, an image (for example, additional information 132) displayed on the second display 385-2 or the sixth display 385-6 may be displayed on the first display 385-1, and an image displayed on the first display 385-1, additional information located above the additional information 132c2 displayed on the second display 385-2 or the sixth display 385-6, or additional information located below the additional information 132c2 displayed on the sixth display 385-6 may be displayed on the second display 385-2 or the sixth display 385-6. In this case, images displayed on the other displays, that is, the third to fifth displays 385-3 to 385-5 and/or the seventh to ninth displays 385-7 to 385-9 may change or not change in response to the command input, according to embodiments.

The display apparatus 300 shown in FIGS. 21 and 22 may be a digital television, an electronic board, a desktop computer, a laptop computer, a monitor apparatus, a smart watch, a smart phone, a tablet PC, a navigation system, a portable game, an electron signboard, or various apparatuses capable of displaying images.

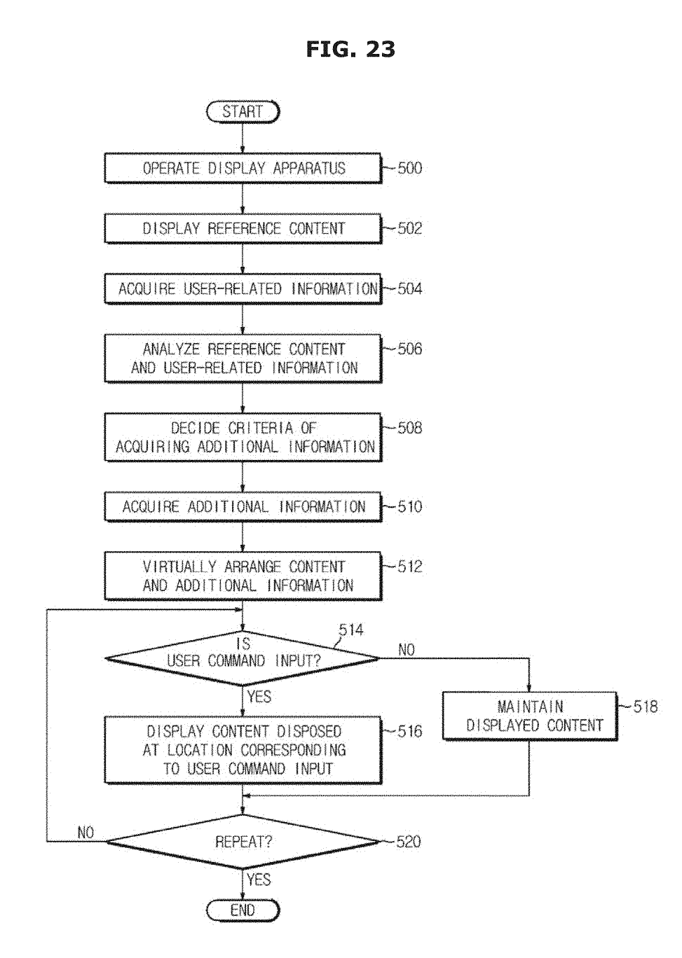

Hereinafter, an embodiment of a method of controlling a display apparatus will be described with reference to FIG. 23.

FIG. 23 is a flowchart showing an embodiment of a control method of a display apparatus.

As shown in FIG. 23, a display apparatus may operate according to a user's operation or a pre-defined setting (for example, watching reservation), in operation 500.

The display apparatus may display content according to a user's operation or a pre-defined setting (for example, content of a most recently selected channel), in operation 502. The content may have been provided from an external content provider.

After displaying the content, the display apparatus may acquire user-related information about the user's preference, the user's behavior, or the user's history, from auxiliary memory of the display apparatus or a terminal connected to the display apparatus in such a way to be communicable with the display apparatus, in operation 504. The user-related information transferred from the terminal may include at least one of content, text, and a use history of the terminal, stored in the terminal.

The display apparatus may analyze the content and the user-related information, in operation 506. The display apparatus may analyze the content immediately after the content is displayed or when a predetermined time elapses after the content is displayed. The display apparatus may analyze the content before acquiring the user-related information.

The content and the user-related information may be analyzed based on at least one of the machine learning, the ROI selection algorithm, and the image segmentation algorithm.

The display apparatus may decide a method of acquiring additional information based on the result of the analysis, in operation 508, and acquire at least one additional information related to the content, sequentially, in operation 510. The additional information may be acquired from a content provider, the auxiliary memory of the display apparatus, or a storage device of the terminal.

After acquiring the additional information, the display apparatus may virtually arrange the content and the additional information, in operation 512. For example, the display apparatus may arrange the content and the at least one additional information according to a predetermined virtual arrangement. The predetermined virtual arrangement may be in the shape of a plane, a sphere, a hemisphere, a cylinder, or a band. When the display apparatus arranges the content and the at least one additional information according to the virtual arrangement, the display apparatus may arrange the content and the at least one additional information according to a degree of association between the content and the at least one additional information, a characteristic of the additional information, and/or a class of the additional information.

Thereafter, the display apparatus may wait a command input from a user.

When the user inputs a user command including at least one direction through a terminal or a remote controller (YES in operation 514), the display apparatus may decide content located in a direction corresponding to the at least one direction with respect to the displayed content (for example, the content), as content that is to be displayed, and display the decided content, in operation 516.

When the user inputs no user command including the at least one direction through the terminal or the remote controller (NO in operation 514), the display apparatus may continue to output the displayed content until the operation terminates according to the user's operation or a predefined setting (NO in operation 520), in operation 518.

Operation 514 of inputting the user command, operation 516 of deciding and displaying the content, and operation 518 of maintaining the content may be repeated until the display apparatus terminates the operations as necessary, in operation 520.

According to an embodiment, at least one of operation 506 of analyzing the content and the user-related information and operation 508 of deciding the method of acquiring additional information may be performed by a server provided separately from the display apparatus. In this case, the display apparatus may transmit the content and the user-related information to the server, and the server may transmit the additional information to be displayed and/or the decided method of acquiring additional information to the display apparatus.

The method of controlling the display apparatus according to the above-described embodiment may be implemented in the form of a program that can be executed by a computer apparatus. The program may include program instructions, commands, data files, data structures, and the like alone or in combination. The program may be designed and produced using a machine language code or a high-level language code. The program may be designed specifically in order to implement the above-described method, or implemented using various available functions or definitions already known to one of ordinary skill in the computer software field. Also, the computer may be implemented by including a processor, memory, etc. for executing the functions of the program, and further include a communication apparatus as necessary.

The program for implementing the method of controlling the display apparatus may be recoded on a computer-readable recording medium. The computer-readable recording medium may include various kinds of hardware apparatuses capable of storing specific programs that are executed according to calls from a computer, etc., such as a magnetic disc storage medium (for example, a hard disc or a floppy disc), an optical storage medium (for example, a magnetic tape, a compact disc, and a Digital Versatile Disc (DVD)), a magneto-optical recording medium (for example, a floptical disc), and a semiconductor storage device (for example, Read Only Memory (ROM), Random Access Memory (RAM), or flash memory).

So far, various embodiments of the display apparatus, the system of controlling the display apparatus, and the method of controlling the display apparatus have been described, however, the display apparatus, the system of controlling the display apparatus, and the method of controlling the display apparatus are not limited to the embodiments. One of ordinary skill in the related art may correct and modify the above-described embodiments to implement various apparatuses or methods, and such apparatuses or methods may also be examples of the display apparatus, the system of controlling the display apparatus, and the method of controlling the display apparatus as described above. For example, the above-described techniques may be performed in a different order from that of the above-described method, and/or the above-described system, structure, apparatus, and components such as circuits may be coupled or combined in a different form from that of the above-described method, or substituted with other components or equivalents. The resultant display apparatuses, systems, and methods may also be embodiments of the display apparatus, the system of controlling the display apparatus, and the method of controlling the display apparatus.

According to the display apparatus, the control system for the display apparatus, and the method of controlling the display apparatus, as described above, it may be possible to properly, easily, and intuitively provide a viewer with information related to content being reproduced or the viewer's desired information, without interfering with the viewer's watching.

According to the display apparatus, the control system for the display apparatus, and the method of controlling the display apparatus, as described above, when the display apparatus provides a viewer with content-related information or information about the viewers desired other content, the display apparatus may prevent the entire or a part of displayed content from being interfered by the information about the content so that the viewer cannot watch the content.

According to the display apparatus, the control system for the display apparatus, and the method of controlling the display apparatus, as described above, since the viewer may check content-related information or information about the viewer's desired other content using a display apparatus which he/she is watching without looking in another display apparatus, the user may need not to turn his/her eyes, and accordingly maintain a sense of immersion.

According to the display apparatus, the control system for the display apparatus, and the method of controlling the display apparatus, as described above, a plurality of viewers may view the same content through different display apparatuses, independently.

According to the display apparatus, the control system for the display apparatus, and the method of controlling the display apparatus, as described above, a viewer may easily, quickly, and conveniently acquire content-related information or information about his/her desired other content.

Although a few embodiments of the present disclosure have been shown and described, it would be appreciated by those skilled in the art that changes may be made in these embodiments without departing from the principles and spirit of the disclosure, the scope of which is defined in the claims and their equivalents.

What is claimed is:

1. A display apparatus comprising:
a receiver configured to receive content;
a display configured to display the received content;
a communicator configured to communicate with a user device and an external server; and
a processor configured to:
acquire information from the user device through the communicator,
request the external server to send additional information related to the received content based on the received content and the information acquired from the user device, and
control the display, when receiving the additional information related to the received content from the external server, to display the received additional information with the received content.

2. The display apparatus according to claim 1, wherein the processor arranges the received additional information around the received content in a shape of a plane, a sphere, a hemisphere, a cylinder, or a band to display the received additional information around the received content.

3. The display apparatus according to claim 1, wherein the processor displays the received additional information around the received content based on one or more of a degree of association between the received additional information and the received content, quality of the received additional information, a preference of the received additional information, a format of the received additional information, and a kind of the received additional information, and
displays the received additional information adjacent to the received content according to the one or more of the degree of association between the received additional information and the received content, the quality of the received additional information, and the preference of the received additional information.

4. The display apparatus according to claim 1, wherein the communicator receives a user command including at least one selection of a direction from the user device, and
the processor decides content disposed in a direction corresponding to the at least one selection of the direction from the content displayed on the display, as content that is to be provided by the display.

5. The display apparatus according to claim 1, wherein the processor analyzes the received content and the information, and conducts a search related to the received content based on a result of the analysis to acquire the additional information.

6. The display apparatus according to claim 5, wherein the processor analyzes the received content and the information based on one or more of machine learning, a region of interest (ROI) selection algorithm, and an image segmentation algorithm.

7. The display apparatus according to claim 1, wherein the information includes one or more of content, text, and use history of the user device, stored in the user device.

8. The display apparatus according to claim 1, wherein the communicator transmits an entire or a part of the received content, an entire or a part of the received additional information, and one or more arrangements of the received additional information to the user device, and
the user device displays at least one of the received content and the received additional information independently or dependently according to a pre-defined setting.

9. The display apparatus according to claim 1, wherein the communicator transmits a text input request to the user device, and receives information about whether text is able to be input from the user device.

10. The display apparatus according to claim 1, wherein the processor requests the external server to send a search method of searching the additional information related to the received content according to information about the received content and the information through the communicator, and
searches the additional information related to the received content according to the search method received from the external server.

11. The display apparatus according to claim 1, wherein the display further comprises a first display configured to display the received content, and one or more second display configured to display the received additional information.

12. A method of controlling a display apparatus, comprising:
receiving information from a user device;
receiving content;
requesting an external server to send additional information related to the received content based on the received content and the information received from the user device; and
displaying, when the additional information related to the received content is received from the external server, the received additional information with the received content.

13. The method according to claim 12, wherein the received additional information is arranged in a shape of a plane, a sphere, a hemisphere, a cylinder, or a band, and displayed around the received content.

14. The method according to claim 12, wherein the displaying of the received additional information around the received content comprises:
displaying the received additional information around the received content based on one or more of a degree of association between the received additional information and the received content, quality of the received additional information, a preference of the received additional information, a format of the received additional information, and a kind of the received additional information, and
displaying the received additional information adjacent to the received content according to one or more of the degree of association between the received additional information and the received content, the quality of the received additional information, and the preference of the received additional information.

15. The method according to claim 12, further comprising:
acquiring a user command including at least one selection of direction from the user device; and
deciding content disposed in a direction corresponding to the at least one selection of the direction from the displayed content, as content that is to be displayed.

16. The method according to claim 12, further comprising acquiring the received content and the information to analyze the received content and the information,
wherein the acquiring of the received content and the information and the analyzing of the received content and the information comprises analyzing the received content and the information based on one or more of machine learning, a region of interest (ROI) selection algorithm, and an image segmentation algorithm.

17. The method according to claim 12, further comprising transmitting an entire or a part of the received content, an entire or a part of the received additional information, and one or more arrangements of the received additional information to the user device, so that the user device displays at least one of the received content and the received additional information independently or dependently according to a pre-defined setting.

18. The method according to claim 12, further comprising:
transmitting a text input request to a user device;
determining whether text is able to be input to the user device; and
receiving information about whether text is able to be input to the user device from the user device.

19. The method according to claim 12, further comprising:
transmitting the received content and the information to the external server;
analyzing the received content and the information by the external server to decide information about acquisition of additional information for the received content; and
receiving the information about acquisition of additional information for the received content from the external server.

20. Control system of a display apparatus, comprising:
an external server; and
a display apparatus communicatively connected to the external server,
wherein the display apparatus acquires content and information, and transmits the content and the information to the external server,
the external server decides an additional information acquiring method based on the content and the information, and transmits the additional information acquiring method to the display apparatus; and
the display apparatus acquires additional information related to the content based on the additional information acquiring method, and displays the additional information related to the content with the content.
